(19) United States
(12) Patent Application Publication
(10) Pub. No.: US 2007/0039024 A1
(43) Pub. Date: Feb. 15, 2007

(54) Olympic event hospitality program management system

(75) Inventors: Dimitar Krajcev, Clifton, NJ (US); Sead Dizdarevic, Far Hills, NJ (US); Sanjin Karabegovic, New York, NY (US); Lisa Dooley, Bernardsville, NJ (US); Mirjana Garcia, Bedminster, NJ (US); Stephen Welch, Sparta, NJ (US); Adam Wixted, Florham Park, NJ (US); Elizabethe Miello, Hackettstown, NJ (US); Brian Mosteller, Chicago, IL (US)

Correspondence Address: PILLSBURY WINTHROP SHAW PITTMAN, LLP, P.O. BOX 10500, MCLEAN, VA, 22102, US

(73) Assignee: Jet Set Sports, Far Hills, NJ (US)

(21) Appl. No.: 11/502,358

(22) Filed: Aug. 11, 2006

Related U.S. Application Data
(60) Provisional application No. 60/707,147, filed on Aug. 11, 2005.

(51) Int. Cl. H04N 5/445; G06F 3/00; G06F 13/00; H04N 7/16; H04H 9/00

(52) U.S. Cl. 725/46; 725/9; 725/45; 725/13

(57) ABSTRACT

The present invention provides a management system based on arranging and managing hospitality accommodations surrounding an event. This is a fully integrated system for scheduling accommodations ranging from ticketing, transportation, hotel, food and beverages, and staff. The system provides its clients with an inventory including rooms, tickets, meals, and other services, which make the present system more of a business partner than just a service provider to its clients. The management system facilitates on-line planning of event hospitality programs specially customized for each client. A client may view an updated program at any time, gather information, make selections and export reports for client's own use. The system provides efficient, quick and accurate information necessary to assist clients in planning aspects of an event hospitality experience.

### CROSS-REFERENCE TO RELATED APPLICATIONS

This application claims the benefit of U.S. Provisional Application entitled “Olympic Event Hospitality Program Management System”, Ser. No. 60/707,147, filed Aug. 11, 2005.

### FIELD OF INVENTION

The invention relates to an integrated system for the creation and management of hospitality programs for Olympic (and other) events, including pre-event activities, onsite logistics, management and communications and post event activities.

### BACKGROUND

The Olympic events are one of the most internationally renowned sporting events. Many people travel great distances to attend these events. Many corporations and other groups plan corporate or group activities involving employees and/or guests. A number of entities provide support for these activities. One example of such a provider is a hospitality program provider. Hospitality program providers for Olympic events may offer one of many services including obtaining tickets, accommodations, local transportation, local food and beverage services, local staff, coordinating gift and collateral for the groups and various other services. The amount of planning and logistics involved in handling some of these hospitality programs can be very significant. In the past, many of these activities were performed manually. This is tedious, time consuming and inefficient. More recently, some aspects of these logistics and management have been automated through the use of computer technology. However, the existing systems have many shortcomings.

In addition to the pre-event activities there is a significant amount of on-site logistics management and communication that may be necessary. As used herein, onsite may refer to the general locality of where the Olympic (or other) event is being held. Prior systems have a limited capability with respect to these on-site activities. One drawback is the inability to effectively and timely communicate changes that may occur at the last minute. Another problem, often exacerbated by the international travel requirements for many who attend Olympic event, is the fact that many people's cell phones, PDAs or other mobile communications equipment may not compatible with local systems. Therefore it may be difficult to effectively communicate last minute information or changes to groups and/or guests.

Additionally, many prior approaches fail to take into account the significant opportunities that may exist for post-event activities including re-marketing other events to corporations and/or guests. These and other drawbacks exist with existing systems and approaches.

### SUMMARY

One aspect of the invention relates to a comprehensive, integrated Olympic event hospitality program. The system enables all (or selected) aspects of the creation, management and implementation of hospitality programs for groups or individuals to be handled through a single, integrated system, including pre-event activities, on site event activities and/or post event activities. If desired, the single system enables or facilitates interaction between the system and some or all of the participants or potential participants. For example, the participants may include internal and external participants. The internal participants may include one or more representatives or employees of a hospitality program provider (including for example, program directors, program managers, hosts/hostesses, drivers, caterers, etc.). The external participants may include one or more corporations or other groups (for convenience often referred to as “groups”). For example, the external participants may include one or more group coordinator, one or more primary guests of the group and/or one or more additional guests of the primary guest, one or more individuals who may desire to purchase a hospitality package through the system, one or more partners of the hospitality program provider (for example, sales agents, local partners, accommodations providers, transportation providers and other partners), employees and/or applicants for staffing the hospitality programs and/other participants.

The pre-event activities may be separated into at least three parts: initial event set-up, third party coordination, and client program set-up and management. The initial event set-up includes various aspects of identifying an event (e.g., an Olympic event), obtaining information and inventory of event related items (e.g., ticket information, accommodations, restaurants and other hospitality venues, potential local service providers etc.), and entering the information and inventory into the system. Other initial event set-up steps may be performed to assist with information needed to plan hospitality program for a large number of groups.

After an event is set up by the hospitality program provider, the hospitality program provider may coordinate and/or contract with third party participants (e.g. local service providers) to provide resources for the hospitality programs to be provided. For example, blocks of hotel rooms may be obtained from one or more local hotels (or other accommodations providers) in order to provide accommodations for group guests. Other third-party service providers may include, but are not limited to, transportation providers, staffing agencies, individual staff, entertainment, food and beverage venues, customized gift vendors and other third party providers.

A contract may be established with these third party participants to provide a certain number of hospitality items (e.g. rooms, vehicles, food/beverages) which may be entered and managed in an inventory database by the hospitality program provider. A large inventory of hospitality items provides more options when making group arrangements.

Another part of the pre-event activities includes creating and managing client programs. After an event and inventory for the event have been created and entered into the system, client programs may be created for one or more client groups (corporations or other groups). With the help of one or more internal participants (e.g., program directors, program managers, etc.) a group coordinator representing a group and/or guests of the group, a client program may be created, entered into the system and managed. A group coordinator may specify the initial group hospitality program parameters for the overall group hospitality program. The parameters may include one or more of: the number of guests; identity of primary guests; guest cycles (e.g., if different guests or groups of guests will be coming and going at different times or for different portions of the event); budget; arrival/departure time and/or mode of transportation to the locale of the event; event selections (tickets/seats to specified events); food, beverage and entertainment options (e.g., including items, venues, staff, etc.); local (and/or other) transportation, gifts, collateral and other parameters desired for the customized hospitality program. Parameters may also be specified in a contract between the group and the hospitality program providers.

The hospitality program provider may assign a program manager (or other representative) to each group and/or one or more program directors to oversee some or all inventory items. According to the hospitality parameters provided by the group coordinator, the program directors may begin to customize the group's hospitality program by allocating to the group hospitality items (food, beverages, accommodations, entertainments venues, event tickets, transportation and/or other hospitality items) from the existing inventory and/or obtaining additional inventory. Program managers may plan and assign the allocated hospitality items for the guests including assigning specific ones of the group allocated accommodations for specific guests (e.g., assigning specific rooms), arranging specific local transportation schedules (e.g. to/from airport, hospitality venues, optional events and/or other transportation needs), including assigning specific vehicles and/or drivers, coordinating gifts and/or collateral for groups/guests, allocating food and beverage arrangements, supplying guests with event tickets for desired events and allocating one or more staff members to each group.

Additionally, the invitees or guests of the group may supply additional pieces of information by registering through the system and/or providing additional information/preferences. Registration may include two parts including initial registration information and event specific information. Initial registration information including general guest information such as mobile phone number, pager, email, address, fax, languages spoken, emergency contact, passport number. Initial (or updated) registration may be used again for future events. The registrant may also provide event specific information including arrival/departure times, accommodation preferences, dining preferences, among other things. Allocation made by the program manger may further be defined using the guest registration information. A guest may also register their mobile device with the system in order to receive on-site updates when they arrive at the event. Guests without mobile device capabilities (or without mobile devices that will function in the even locale) may submit a request to be supplied with a mobile device upon reaching the event.

Group coordinators, invitees (guests), program directors and program managers may define all (or most) parts of a hospitality program including program schedule, program timeline and specific allocation of hospitality items (e.g. accommodations, tickets, transportation, schedules). During the creation of a hospitality program it may be determined that additional services from third party participants may be desired. Based on demand and number of people, additional inventory can be purchased by the hospitality program providers in order to ensure guests have sufficient arrangements.

On-site activities may include the timed execution and staffing of each scheduled item in the program schedule. From the group(s)' arrival to the group(s)' departure, aspects of the hospitality program (including resources and staff) may be scheduled according to the program schedule. In order to enable effective and timely communication staff and guests may be provided a mobile communications device may be provided to each guest of the group. Or the system may communicate with existing mobile devices that function at the event location. Either way, each group and guest profile may be updated to include mobile device identification and instructions on how to send information and contact each mobile device assigned or belonging to the guest. Staff members may also be equipped with mobile device capabilities. Communications may be arranged based on guest/group profiles, wherein real-time updates based on profile is received. Also available through the mobile device communications is the ability to receive daily schedules, receive updated event information, receive hospitality information, and request additional hospitality arrangements. This further enables users to receive real time scores/results from other events of interest. Staff and/or internal participants may also receive real-time updates regarding hospitality arrangements, staffing changes, program schedules or other information regarding the logistics and/or management of the hospitality program(s) for one or more groups. This scope of real time communications is facilitate by the comprehensive integrated nature of the system.

The post-event activities may include one or more of marketing future events to corporate groups or guests, advertising event related merchandise, sending thank you messages, finalizing account balances, addressing complaints made during the event, and surveying corporate groups to evaluate the hospitality program. Clients of the system including corporate groups and individuals, makeup a target audience for receiving follow up information with respect to goods, services, and future events that may be of interest to the group based on stored corporate profile, guest and individual guest information.

According to another aspect of the invention the system may be fully or partially integrated with other business systems to enable more complete automation of many tasks that may previously have been done manually by a hospitality program provider and/or to integrate into a single system computer implemented components that may have been parts of disparate computer systems in the past, to enable more complete collaboration between the system and both internal and external participants during pre-event activities, onsite management and any post event activities for one or more Olympic (or other) events.

For example, the system enables the integration of internal operations (e.g. of the hospitality program provider) and external communications with participants. For example the system enables integration of a hospitality program provider's internal management systems (including one or more of its events related inventory management system, accounting system, on-line sales system, employment, ticketing, web site creation, guest registration, and report module, among others) with inbound and outbound external communications (including one or more of wired, wireless, satellite, PSTN, and/or fiber optic connections, among others). Additionally, for one or more corporate clients or other groups, the system may include a customized web site for that group, with access to various reports with respect to hospitality arrangements made for the group.

This integration provides a number of important benefits including the ability to generate and leverage real time information for both internal management and external communications. For example, the system enables both internal and external participants to receive alerts and notifications regarding information from the management system. This allows the seamless execution of the hospitality program during the event. For example, an external participant is able to request additional hospitality (e.g. transportation) during an event if the need arises.

According to one embodiment of the invention, the event management system 2 includes: an inventory database for storing data related to accommodations, event tickets, hospitality packages, food/beverages, transportation, hospitality passes, staff, corporate profiles, corporate guests, and/or individual guests; management departments for administration, accounting, ticketing, accommodations, employment, on-line sales, transportation, food/beverages, communications and/or marketing; and hospitality program providers including program directors and program managers; customer database 6 may store corporate profile, account profiles, guest profiles, and on-line guest profiles; an allocation database 8 may store program timeline, program schedules, guest registration information, allocated accommodations, transportation, staff, gifts, passes and event tickets. A program director may be assigned to each management department to oversee aspects of the inventory database corresponding to that management department.

The management system is fully integrated for scheduling aspects ranging from ticketing, transportation, hotel, food and beverages, and staff. The system provides clients with an inventory including rooms, tickets, meals, and other services. The management system facilitates on-line planning of event hospitality programs specially customized for each client. A client may view client hospitality program at any time, gather information, make selections and export reports for client's own use from the client hospitality system. The system provides efficient, quick and accurate information necessary to assist clients in planning aspects of an event hospitality experience. The two main function of the management system include internal inventory management and reporting, and the management of multiple hospitality programs.

The system includes a database and event management system (called management system for convenience) which allows detailed event planning. The database provides accuracy, efficiency, and maximizes the objectives of each client hospitality program. The management system provides up-to-date program information available any time via the Internet to clients, subject to authorization level. Each client may access their hospitality program through a dedicated client web page customized with database reports of the program schedule, timeline, food and beverage functions, rooming lists, ticket allocations, arrival and departure manifests, vehicle movements and staff schedules. Each guest is provided with an on-line guest registration which tracks any changes to the guest's profiles. Any changes to the hospitality system are tracked and may be emailed to program mangers and/or client guests.

Management services include an expertise in operations, ticketing, transportation, and catering. These departments work together seamlessly to provide hospitality program. Depending on needs, each program can be managed by professional event staff who will oversee aspects of day-to-day operations.

In operation, different participants interact with the system in different ways and/or at different times (for example, pre-event, onsite and post-event). For example, various different internal participants may use the system in the following exemplary fashion. During pre-event activities, internal participants may identify the event for which hospitality will be provided and based on event information may begin to establish third-party participants such as local service providers from which hospitality items may be purchased. An internal inventory may be created according to the hospitality items supplied by these third party participants. The inventory may be used to create hospitality programs to interested individuals or corporate clients wanting to arrange hospitality for a group of primary guests or employees and their guests to the event. Contract terms may be established for each corporate client or other group in order to supply internal participants some guidance when creating a hospitality program. Scheduling each event and hospitality arrangements may be shared with corporate clients and their guest through a dedicated home page.

In addition, the management system may provide an administration component. During pre-event activities (or other times), the administration component may be used for creating and maintaining program manager profiles including, assignment of program managers to groups and/or guests, specific program manager roles and/or program manager permissions. A program manager may be supplied with an interface limited to the boundaries set within the profile. The pre-event activity steps may be used to coordinate as many aspects of hospitality before the arrival of the guests at the event location.

Internal participants use the event management system for on-site activities of each scheduled item in the hospitality program schedule. On-site activities ensure aspects of the hospitality schedule are carried out seamlessly, from meeting guests at the airport, escorting guests to and from events, and requesting additional arrangements as the need occurs. Post-event management allows internal participants the chance to plan future events for the corporate client and also follow up with information regarding other goods and services provided by event organizers and/or merchandisers.

Various different external participants may use the system in the following exemplary fashion. A corporate group is an external participant for which hospitality programs may be created and maintained. During pre-event activities, a group coordinator may be assigned to manage invitations to the event, set a corporate budget, coordinate allocation of hospitality items to guest and, access a web page dedicated to providing information regarding the hospitality program. Corporate groups may also be supplied on-site use of the management system via mobile devices accessing various aspects of the management system for supplying real-time alerts and notifications based on venue information, event information, and/or hospitality information. The corporate client may also submit requests to the management system during the event. Post-event access to the management system allows the corporate client to access account statements, fill out evaluations, view response to complaints, receive information regarding event related merchandise and information on future events of potential interest.

In addition to corporate clients, external participants also include individual guests, employment applicants, and third party participants. Individual guest access the event management system using an online sales web-site via Internet, which allows individual guests to purchase hospitality packages directly from inventory. Employment applicants may also use a web-site supplied by the event management system to apply for open staff positions. And third party participants include resellers and/or service providers (e.g. drivers, restaurants, hotels, etc.). Optionally, if a service provider inventory is implemented in a computer based system, the event management system may be linked directly with the service provider in order to obtain hospitality inventory.

### BRIEF DESCRIPTION ON DRAWINGS

These and other features, aspects and advantages of the present invention will become better understood with reference to the following description, appended claims, and accompanying drawings where:

FIG. 1 is a block diagram of the management system in connection with the networking environment, according to an embodiment of the invention.

FIG. 2 is flow chart for the method of performing pre-event activities, according to an embodiment of the invention.

FIG. 3 is a flow chart for the method of performing program scheduling, according to an embodiment of the invention.

FIG. 4 is a flow chart for the method of performing on-site activities, according to an embodiment of the invention.

FIG. 5 is a flow chart for the method of performing post event activities, according to an embodiment of the invention.

FIG. 6 is a screen shot of a login to the management system, according to an embodiment of the invention.

FIG. 7 is a screen shot of a manager profile, according to an embodiment of the invention.

FIG. 8a-8d are screen shots of the program manager's views of program scheduling, according to an embodiment of the invention.

FIG. 9a-9f are screen shots of the program manager's views for the online sales, according to an embodiment of the invention.

FIG. 10a-10g are screen shots of the program manager's views for ticket inventory, according to an embodiment of the invention.

FIG. 11a-11i are screen shots of the program manager's views for transportation, according to an embodiment of the invention.

FIG. 12a-12f are screen shots of the program manager's views for accommodations, according to an embodiment of the invention.

FIG. 13a-13d are screen shots of the program manager's views for food and beverages, according to an embodiment of the invention.

FIG. 14a-14f are screen shots of the program manager's views for employment, according to an embodiment of the invention.

FIG. 15 is a sample screen shot of the program manager home page, according to an embodiment of the invention.

FIG. 16 is a sample screen shot of a guest registration user interface, according to an embodiment of the invention.

FIG. 17 is a screen shot of the client program view for timeline, according to an embodiment of the invention.

FIG. 18a-18b are screen shots of the client program view for Olympic events and tickets, according to an embodiment of the invention.

FIG. 19a-19b are screen shots of the client program view for program schedule, according to an embodiment of the invention.

FIG. 20a-20c are screen shots of the client program view for food and beverage, according to an embodiment of the invention.

FIG. 21a-21d are screen shots of the client program view for guest registration, according to an embodiment of the invention.

FIG. 22a-22b are screen shots of the client program view for transportation, according to an embodiment of the invention.

FIG. 23 is a screen shot of the client program view for city guide, according to an embodiment of the invention.

### DETAILED DESCRIPTION

The present invention relates to a system and method for providing management services to coordinate some or all aspects of hospitality program surrounding an Olympic (or other) event. Some functions of the management system 2 include internal inventory management and reporting, and the management of multiple hospitality programs, for multiple groups (and for multiple events). Internal inventory management and reporting covers at least some of accommodations, transportation, ticketing, food and beverages, hospitality passes, staff and other hospitality program parameters.

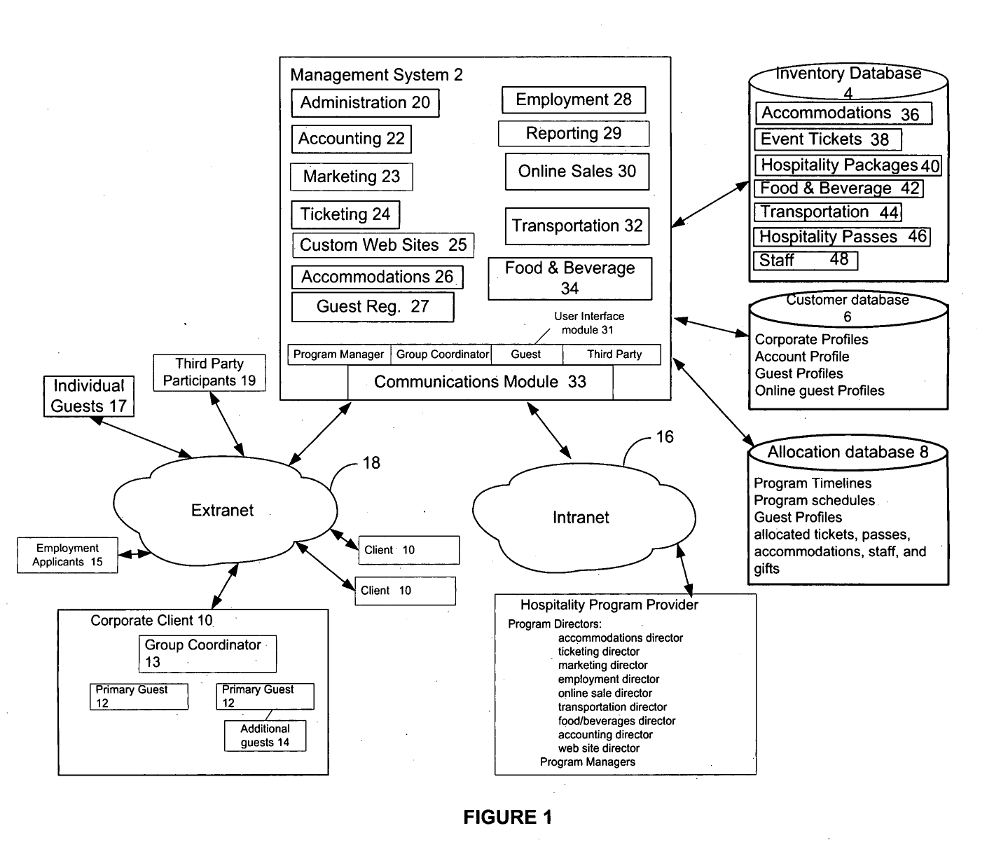

FIG. 1 refers to one example of an event management system 2 of the present invention. The system may be linked at least through a private network in the form or the intranet 16 and a public network in the form of an extranet 18. Intranet 16 provides a private and more secure access to the management system 2 which-allows internal participants (such as program directors and program managers) control over at least various management aspects shown in the event management system 2. Program directors may oversee the management and inventory within the inventory database 4. Program managers may manage each group. Those and other roles may be performed by one or more personnel. External participants include employment applicants 15, individual guests 17, third party participants 19, corporate clients 10, each of which may have a number of guests, including a plurality of primary guests 12, additional guests 14, one or more group coordinator 13, and other external participants. External participants access the system through the extranet including Internet.

Both internal and external participants may access the event management system 2 in various ways in order to conduct pre-event activities, on-site activities and post event activities. The pre-event activities may be separated into at least three parts: initial event set-up, third party coordination, and client program set-up and management. On-site activities may include the timed execution and staffing of each scheduled item in the program schedule. In some cases, internal participants may include the staff members such as program managers, program directors, host, hostesses, drivers, caterers, servers and/or tour guides, employed by the event management system. These internal participants can access the management system 2 to perform pre-event activities through the secure intranet. During on-site activities, internal participants located on-site may employ mobile devices connected through public network connections. The post-event activities may include one or more of marketing future events to corporate groups or guests, advertising event related merchandise, sending thank you messages, finalizing account balances, addressing complaints made during the event, and surveying corporate groups to evaluate the hospitality program.

Pre-Event Activities

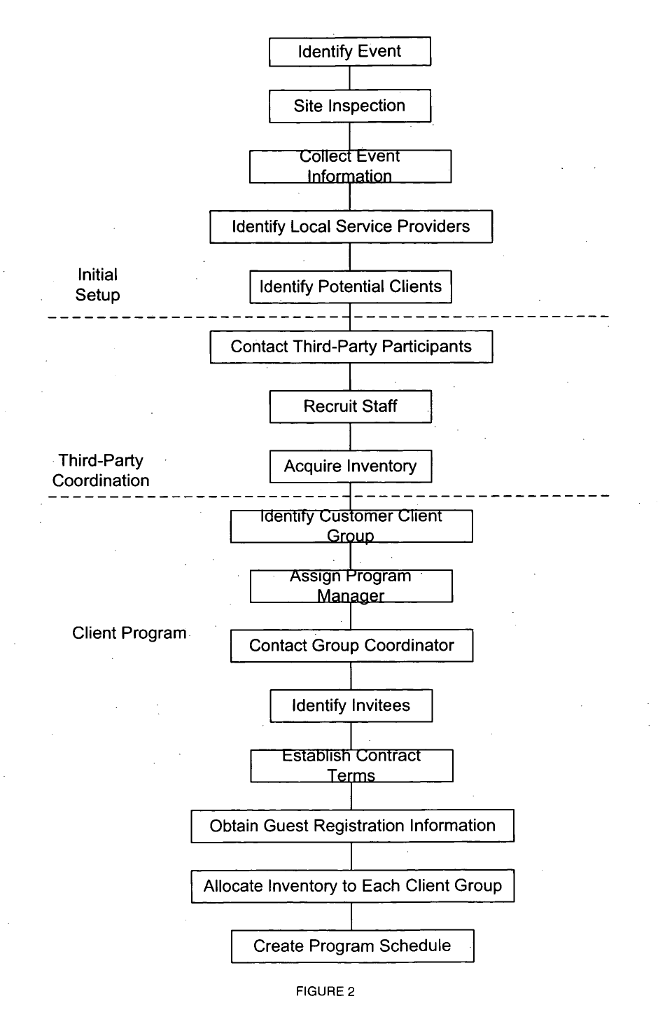

Event related and hospitality program parameters may include, but are not limited to, event tickets, accommodations (e.g. hotel, condominium, home share, hostel, and other accommodations), transportation (e.g. van pools, bus, taxi, car service, etc.), food/beverages (e.g. breakfast, lunch, dinner), and/or staff (e.g. hosts, drivers), entertainment between events, collateral for the event (e.g. mailers, welcome kits, signage, and other collateral), and gifts (e.g. event memorabilia, postcards, pictures, souvenirs, event collectables, pins, buttons, gift cards, and other gifts). As depicted in FIG. 2, the stages of pre-event activities included initial event set-up, third party coordination and client program management. Pre-event activity begins internally with the initial event set-up including identification of an event or events for which the event management system 2 will provide hospitality programs and packages. The initial event set-up includes various aspects of identifying an event (e.g., an Olympic event), obtaining information and inventory of event related items (e.g., ticket information, accommodations, restaurants and other hospitality venues, potential local service providers etc.), and entering the information and inventory into the system. Initial event set-up will determine potential local service providers (e.g. hotels, restaurants), public transportation routes, road maps, weather conditions during the event, event venues, venue seating capacities, available tickets, and other information needed to plan hospitality program for a large number of groups. Internal participants, mainly program directors manage the various aspects of the management system 2 including accounting 22, ticketing 24. accommodations 26, employment 28, online sales 30, transportation 32, food and beverages 34, web sites 25, guest registrations 27, reporting 29, user interface 31, and marketing 23.

A program director begins by collecting hospitality inventory for the event according to the event site inspections. Third party coordination may involve contacting and forming partnerships with local hospitality providers. After an event is set up by the hospitality program provider, the hospitality program provider may coordinate and/or contract with third party participants (e.g. local service providers) to provide resources for the hospitality programs to be provided. For example, blocks of hotel rooms may be obtained from one or more local hotels (or other accommodations providers) in order to provide accommodations for group guests. These hospitality providers may be best characterized as third party participants 19, who may supply the event management system 2 with hospitality inventory items (e.g. hotel rooms, apartments, vehicles, food/beverages, tickets, staff). Other third-party service providers may include, but are not limited to, transportation providers, staffing agencies, individual staff, entertainment, food and beverage venues, customized gift vendors and other third party providers. A contract may be established with these third party participants to provide a certain number of hospitality items (e.g. rooms, vehicles, food/beverages) which may be collected and managed in an inventory by the hospitality program providers. A large inventory of hospitality items provides more options when making group arrangements.

The third aspect of pre-event activity is creating and managing a customized client program (e.g. hospitality program). After an event and inventory for the event have been created and entered into the system, client programs may be created for one or more client groups (corporations or other groups). During pre-event activities, an important aspect is to recruit clients to use the event management system. Corporate groups being the most sought after because the number of guest they can accommodate may be greater. For example, a corporate client may invite employees and employee family members as guests to an event. One or more client groups may be related to a client account and/or client program. A profile for the client account may include general and specific information about a client program. As corporate clients or other groups are established as client groups of the event management system, a program manager can be assigned to each corporate client or other group.

One or more client and/or groups may be assigned an internal participant (e.g., program manager). An administration component of the event management system may enable such assignments. The internal participant may manage aspects of the client and/or group's entire hospitality program or a part thereof. The internal participant assigned to manage the group may have a manager profile which includes assignments of the internal participant to a client's hospitality program or assigned part(s) thereof, manager specific roles, and/or permissions. The assigned internal participant may be presented with an interface. The interface may be limited to the boundaries pursuant to the permission sent in the manager's profile.

With the help of one or more internal participants (e.g., program directors, program managers, etc.) a group coordinator representing a group and/or guests of the group, a client program may be created, entered into the system and managed. A group coordinator may specify the initial group hospitality program parameters for the overall group hospitality program. The parameters may include one or more of: the number of guests; identity of primary guests; guest cycles (e.g., if different guests or groups of guests will be coming and going at different times or for different portions of the event); budget; arrival/departure time and/or mode of transportation to the locale of the event; event selections (tickets/seats to specified events); food, beverage and entertainment options (e.g., including items, venues, staff, etc.); local (and/or other) transportation, gifts, collateral and other parameters desired for the customized hospitality program. Parameters may also be specified in a contract between the group and the hospitality program providers. Based on parameters settled in contract agreements (e.g. budget, number of guest, days, corporate signage, event ticket preferences, gifts/collateral etc.), a hospitality program may be created for the corporate group. The contract aids in allocating certain hospitality items to the clients hospitality program and establishing gifts and collateral to be created before the event. Gifts may include welcome and departing souvenirs and collateral such as corporate signage, pre-event mailers, and guest ID cards may be printed in advance.

A web-site dedicated to the corporate group's hospitality program may be created in order to share hospitality program information with each corporate group. The web-site may be part of the system or a separate website that may communicate with the system. The dedicated web-site also facilitates a guest registration component wherein guest registration information may be used for one or more events. Additionally, based on integration with other components of the system (e.g., the inventory database), the system may automatically (or manually) enable a determination of which hospitality inventory items can/should be allocated to the guest. In addition to the dedicated hospitality program web site for each corporate client, a mailing schedule may be executed for sending guests save the date cards, invitations, RSVPs, thank you for accepting cards, and event information via mail, electronic mail or otherwise. Mailings before the actual event provide guests with pre-event information and reminders to help corporate groups prepare for the event. Various types of collateral may be sent.

External participants, corporate clients 10, employment applicants 15, individual guests 17, and third party participants 19, may partake in pre-event activities via the system too. Each external participant may play a role in pre-event activities. First, corporate clients 10, as discussed above, may have a group coordinator 13 arranging the hospitality parameters with the event management system 2 including an assigned program manager. The group coordinator also may send out invitations to those who should be invited to the event. Invitations may indicate-number of additional guest that may be allowed for each invitee or primary guest 12. As the guests confirm their invitation, the corporate group 10 is established as client group of the event management system 2. Accordingly, pre-event activity information including hospitality program created by the event management system 2 may be shared with members of the group (e.g. group coordinator and primary guests) using a dedicated corporate client web-site hosted by the event management system 2. Information in the web-site regarding the- hospitality program may include, but is not limited to, program timeline, program schedule, food/beverages, events, guest registration, airport manifest, accommodations, transportation, gifts, letter of operation, staff and/or city guide, each explained in further detail below.

Guest registration information may be communicated to the management system 2 using the web-site. Registration may include two parts including initial registration information and event specific information. Initial registration information including general guest information such as mobile phone number, pager, email, address, fax, languages spoken, emergency contact, passport number. Initial. registration may be used again for future events. While a more specific set of information related to the event may include arrival/departure times, accommodation preferences, dining preferences, among other things. A guest may also register their mobile device with the system in order to receive on-site updates when they arrive at the event. Guests without mobile device capabilities (or without mobile devices that will function in the even locale) may submit a request to be supplied with a mobile device upon reaching the event.

Another external participant is the employment applicant 15. Potential employees may apply to work for the event management system 2 during the event. Staff may include, hosts, hostesses, drivers, etc. The event management system 2 hosts an employment web-site which may be accessed in order to fill out an employment application. As employees are hired, they become part of the inventory used to create hospitality programs. Hosts or hostesses may be assigned to a corporate client based on language needs or other corporate preferences.

Yet another external participant is an individual guest(s) 17, individual guests may or may not be associated with a corporate client. Event pre-planning for individual guests may include at least ordering hospitality packages and maintaining order information. The individual guest accesses an online sales web site provided by the event management system, which provides predetermined hospitality packages for the event. Hospitality packages include, at least one event ticket in combination with accommodations, transportation, and/or food/beverages. As hospitality packages are purchased the inventory is updated to reflect the order status and sold packages. Although an individual guest may or may not receive most of the features provided to a corporate client, the order information is maintained so that it may later be accessed by either the individual guest or an online sales director.

Third party participants 19 may communicate with the event management system 2 via public network, therefore making it an external participant. Third party participants, may include external suppliers of hospitality inventory such as, hotels, property managers, restaurants, ticketers, vehicle providers, and other service providers who offer hospitality. Inventory may be acquired or purchased from third party participants. Optionally, a contract with hospitality providers may be established based on event location and/or the hospitality providers location with respect to event venues. Specific types of hospitality providers may be desired for different corporate groups depending on group preferences such as price, diet restrictions, location, pet policy, handicap accessibility, and other preferences. Third party participants may or may not limited to hospitality suppliers. They may include package-resellers and or event partners.

On-Site Event Activities

The internal participants, program managers and program directors, in particular, can manage aspects of the hospitality program during the execution of an event and the hospitality schedule. Upon arrival and during the event, corporate client's guests may be met and escorted by hospitality staff. At arrival a driver may be arranged to pick up the guest according to travel information entered by the guest during the pre-event activity stage. Drivers will be supplied with guest information in order to facilitate quick and easy pick up. The guest or group may be driven to the hotel, where upon arrival and check in to the hotel each guest may receive a welcome kit. Followed by guest credentials or ID cards to be used to identify a guest as group member. The execution of these aspects may be coordinated by host or hostesses of the hospitality program. A group may then be driven to event venues, prearranged dining establishments, entertainment venues and other location according to the program schedule. During events, a group may be provided with on-site signage, a feature beneficial to corporate groups wanting to advertise their participation in the event. Before departure from the event, the group may be supplied with departure notices informing them of transportation back to the airport and the closing of any open account balance accrued by a guest.

The event management system 2 may include on-site interactive communications during the event and execution of hospitality program. The management system 2 may include multiple mobile devices assigned to staff members and corporate groups for providing real-time information regarding the management system 2 while at an event. Or the system can be made compatible with the guest's existing mobile device that functions at the event location. Either way, a group, guest profile, and staff profile may be maintained to include mobile device identification and instructions on how to send information and contact each mobile device assigned or belonging to the guests and/or staff. Optionally, a mobile device may be embedded with GPS tracking chip which allows the user to be located. Staff members may also be equipped with GPS mobile device capabilities. Update's may be arranged based on group, guest and/or staff profiles, wherein real-time updates may be received based on profile information. Also available through the on-site mobile device communications is the ability to receive daily schedules, receive event information, receive hospitality information, and request additional hospitality arrangements. On-site activities allows users to view the most up to date scores from other events of interest and includes real-time updates regarding hospitality arrangements, while providing staff a complete view of the current execution of the program schedule. Mobile devices may be connected through local wireless access point or cellular internet connection, to interface with pieces of the event management system 2 to receive real-time reports based on daily program schedule, event changes, updates, alerts, transportation schedule, additional transfer request, and/or vehicle/driver allocation.

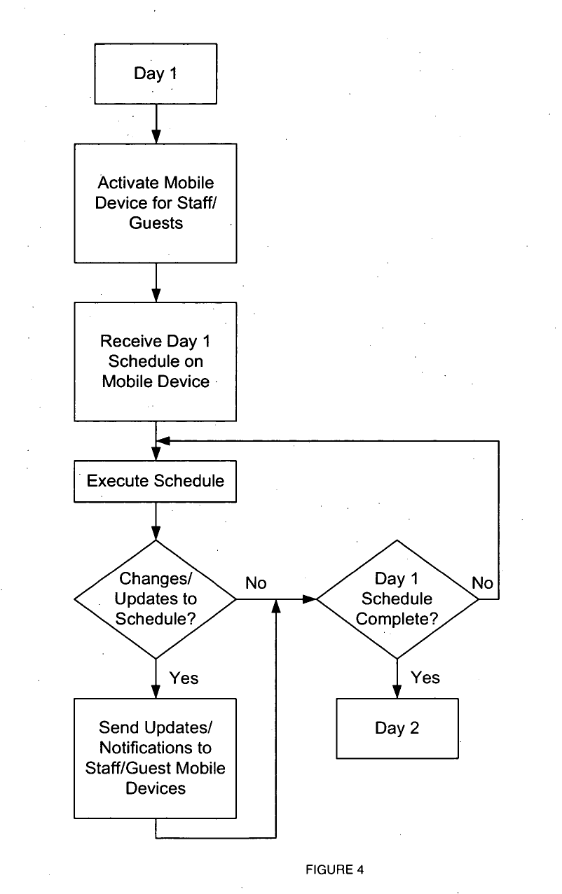

As depicted in FIG. 4 each staff and guest mobile device is activated at Day 1 of the event and daily schedules may be sent to each device in order to execute the schedule. Any changes or updates to the schedule may be sent to the corresponding group and staff members until the Day 1 schedule is completed. This procedure is followed until the end of the final day of the event. Thus, mobility allows program managers and support staff the ability to adapt to real-time events in order to provide quick response to the group's needs. A live schedule may be tracked by staff members during the days of the event to ensure the program schedule is kept and executed according to plan. However, if changes do occur, the management system 2 can be modified to record the changes. Alerts based on changes may be sent out to predetermined users of mobile devices to further ensure that staff and guest may be notified of changes to a schedule or hospitality arrangements.

An added service to corporate groups is an event information feature which allows mobile devices assigned to the corporate groups to receive event information regarding such things as live event scores, athletes standings, player statistics, instant reply clips, venue maps, seating diagram, weather reports, and other event related information. The event information feature of the mobile device adds greater value to the guests of the corporate event. Not only can it receive full hospitality arrangements but may also have the added benefit of being able to receive real-time information regarding other events happening at the same time. For example, during an Olympic event there may be multiple sporting events occurring simultaneously. While attending one of these events, a mobile device may provide a group with live updates from another event.

Another feature of on-site activities allows corporate groups to request additional hospitality arrangements. For example, the event management system 2 allows guests to request additional vehicle transportation between event, dining, and lodging locations. If at anytime a corporate guest would like to receive hospitality arrangements that exceed the prearranged hospitality items, the corporate guest may choose to purchase the additional arrangements on their own. This may be helpful for guests who wish to upgrade accommodations if corporate accommodations may be insufficient. Although, each corporate guest is best accommodated during pre-event activity stage, a guest may change his or her mind once they have reached the event.

A computer-based mobile device with access to network capabilities can be programmatically linked to the management system 2 to receive notifications and updates in real-time. With similar access to mobile devices, a program manager may also be able to receive real-time notification and updates. Information relating to a hospitality program may be communicated to predetermined mobile devices. As disclosed above event information, for example, duration, program information, and venue information may be sent to a client's mobile device at the beginning of the event. Furthermore, hospitality details may be sent to specific on-site program manager responsible for a particular group. Thus, information is sent to mobile devices participating in the hospitality program that need it. The mobile devices provide on-site interactive communications during the event and execution of the hospitality program. The event management system 2 can manage multiple corporate clients using the present system by assigning each mobile device used by a corporate group a different identifier. Each profile may be updated accordingly with group identification information. This will ensure event and hospitality notifications and alerts may be sent to the corresponding client group(s).

In an alternative embodiment, users of the management system 2 may request to receive real-time updates on a specified piece of information relating to the hospitality program. This allows clients, guests and program managers a customized view of real-time information relating to their specific role or interest.

Post Event Activities

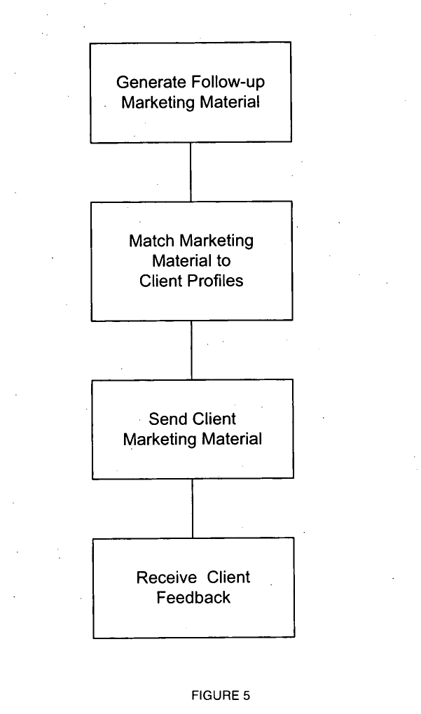

FIG. 5 shows a method for conducting post event activities wherein follow-up material is generated and matched to client profiles, (e.g. corporate client, guests, online customers) and then sent to the client. The marketing material may elicit feedback from the client allowing the hospitality program providers additional information on future events and referrals to other potential client groups. Post event activities may be implemented for corporate clients and individual guests of the management system 2. For corporate groups, each guest and/or the group coordinator 13 may be targeted to receive follow up marketing information including, but not limited to, future events, event memorabilia, accommodation specials, and/or dining specials. Furthermore, as a corporation, organizers of other events may be interested in forming partnerships and/or event sponsorship opportunities with a corporation that has a known interest in a particular type of event. A corporate profile, group profile and individual guests profile may be maintained for these purposes. Previous event and hospitality related information may also be maintained in order to quickly assemble new event hospitality programs based on the maintained information and any additional information that may be desired.

Post event activities may also include sending a survey or evaluation form to each guest in order to rate their event and hospitality experience. This information may be recorded and used for future event hospitality programs for the corporate group or other corporate groups. In addition, each corporate group may receive thank-you cards and/or gifts from the management system 2 as part of the contract agreement. In order to customize a gift, a corporate logo in combination with event symbol may be included. These post event activities may also be used to create client loyalty so that corporate groups plan future events using the management system.

Description of Management System Components

The management system 2 provides an interactive, dynamic online database system for inventory management and reporting various aspects of a hospitality program created for a client. The client may include a corporate entity or organizational entity wanting to arrange event planning and accommodations for their guests. The management system 2 may register the group of guests under the client. Accordingly, hospitality program parameters may be specified for a client hospitality program for the group of guests. The management system 2 integrates input and other information from internal and external participants to assemble a customized client hospitality program and/or packages. An on-line sales component allows individual guests (e.g., not associated with groups) to purchase customized hospitality packages directly from the management system. Hospitality packages may include one or more of accommodations, transportation, food and beverages, event tickets and/or other hospitality related items. Alternatively, the hospitality package could include a customized combination or a single hospitality option. Regardless of the actual hospitality program eventually assembled for the client and/or individual guests, an inventory database provides a full report of available hospitality items to a management team assigned the duty of creating the client hospitality program and assigning specific items to guests or individuals. Some or all of the assignments may be automatic.

The management system 2 may be a web-based application based on Microsoft SQL Server-and Microsoft ASP.NET technology which allows rapid response to client requests. The Microsoft SQL Server relational engine supports high speed transaction processing. Microsoft Active Server Pages is a server side scripting environment that is used to create and run dynamic interactive web server applications. ASP allows the combinations of HTML pages, script commands, and COM components to create interactive web pages as part of a powerful web based management system 2 that are easy to modify and customized for each client on the fly, based upon their actions or requests.

As the client hospitality program is created and modified, pre-event activities may include defining financial aspects, number of customers desired, cycles of attendance, accommodations, game tickets, and transportation. Hospitality may be efficiently arranged and managed by the management system 2 for each of the client's guest from their point of arrival to the time of their departure. According to FIG. 1, the management system 2 is divided into management departments, each of which controls a different aspect of the hospitalities offered by the system. Each department may have a program director who oversees control of corresponding inventory items and each client may have a program manger assigned. A program director's workstation and program manager's workstation may be linked to the same intranet 16 as the management system 2.. In an alternative embodiment, both the program manager and program director can access the management system via remote access capabilities if desired. FIG. 1 shows a management system 2 comprising management modules for administration 20, accounting 22, ticketing 24, accommodations 26, food and beverages 34, online sales 30, transportation 32, marketing 23, reporting 29, guest registration 27, websites 25, employment 28, communications module 33, and/or user interface modules 31. The inventory database 4 may store information relating to accommodations 36, event tickets 38, hospitality packages 40, food and beverages 42, transportation 44, hospitality passes 46, and/or staff 48. A customer database 6 may store corporate profiles, account profiles, guest profiles, and on-line guest profiles. An allocation database 8 may store program timeline, program schedules, guest registration information, allocated accommodations, transportation, staff, gifts, and event tickets.

According to FIG. 1 three databases are depicted to show an inventory database 4, customer database 6, and allocation database 7. More or less may be used and aspects of the databases shown may be combined if desired. Inventory database 4 may include available hospitality items and an status indication of whether they have been allocated to a group or online guest. Customer database 6 may store profile information for users of the management system including corporate profiles, account profiles, guest profiles, on-line guest profiles, and staff profiles. In addition to profile information, the customer database 6 includes mobile device information for on-site activities. This information may include how to reach mobile device, and types of information that should be sent to mobile device. The allocation database 8 stores information regarding allocated inventory and client program information. Such items as, program schedules, program timeline, guest registration information, allocated accommodations, transportation, staff, gifts, and event tickets may be maintained for each group. Therefore, the allocation database 8 can best be viewed as a combination of inventory and profile information, wherein as soon as available inventory becomes allocated to a group or guest, the association gets stored as an entry in the allocation database 8. For FIG. 1, each management component, inventory item, and database is explained.

A communications module 33 allows the management system to communicate via wired, wireless, satellite, PSTN, and/or fiber optic connections, among others. User Interface module 31 provides a program manager, group coordinator, guests, and third party participants restricted access to the management system using different login and password credentials. Information may be displayed via a customized web page provided by web site module 25. The information may include reports based on allocated inventory.

Administration component 20 may be used for creating and maintaining program manager profiles including, assignment of program managers to groups and/or guests, specific program manager roles and/or program manager permissions. A program manager may be supplied with an interface limited to the boundaries set within the profile. The pre-event activity steps may be used to coordinate as many aspects of hospitality before the arrival of the guests at the event location.

The accounting management component 22 provided by the management system 2 maintains a cost breakdown of items within the inventory and for each client group. Accounting reports allow accounting directors and program managers to control cost, perform financial analysis, manage budget, and provide forecasting. Thus, hospitality programs for each client may be created to stay within budget, while on-line sale figures may be used to forecast the need for more inventory. Excess inventory may be calculated and used to determine new allocations and sale prices. Reports may be posted to accounting software of a program director or program manager's preference.

The marketing component 23 accesses the collected customer profile information from database 6 based on corporate profiles, guest information, and individual (e.g. on-line customers) guest information. The present system allows client information, as it is received, to be stored at the customer database 6. After the completion of a successful hospitality program and event, clients and clients' guests may be interested in follow-up information regarding similar events for which the client and/or individual guest may have an interest in attending. Client information may also be shared with these other event organizers as a set of potential clients to target for future events, related merchandise and memorabilia. As the client list grows, the management system may market the client inventor information to even more event organizers, merchants, and/or service providers. Since client information can be saved for subsequent events, the process of providing follow-up hospitality programs becomes more efficient and reliable for clients and their guests. For example, a guest will be more motivated to attend an event knowing that the hospitality program will be similar and as satisfying as the hospitality program provided at a previous event.

The management system, 2 enables a ticketing system 24 hosted on the secure server with secure access to only authorized management/personnel. The ticketing system is fully interactive with the client hospitality program schedule from the initial import of the selected ticket allocation into the schedule to the tracking of any additional sales. Event ticket information includes event time and duration. This information forms the program schedule for which other items may be scheduled around. A ticket inventory is created based on the event organizers responsible for distribution of tickets. Tickets may be allocated to a client group and such information is loaded into the client groups home page and program schedule to form the backbone of the event hospitality program schedule. Other aspects of the hospitality program may be used to accommodate and facilitate the attendance at the event(s) for which tickets have been allocated and sold. A ticketing director may allocate a number of tickets in the inventory for on-line sales and may choose to change these allocations at any time. Thus, the ticket director has the ability to track and monitor the entire inventory of tickets, ticket sales by quantity, value and purchaser, and also the excess unsold or unallocated inventory. Seat assignments may also be made according to online seating diagrams and venue diagrams. Therefore, a guest requiring special arrangements may be accommodated during the event.

Custom website module 25 and reporting 29 may function together to present groups with detailed views of allocated hospitality items from allocation database 8. Each client may access a custom group web-site which reports the program timeline, program schedule, guest registration information, allocated accommodations, transportation, staff, gifts, and event tickets stored by the allocation database for each group. In this manner, each module allows the full integration of information regarding hospitality and group information.

Internal inventory management and reporting allows a program director to create and manage inventory items. For accommodations management 26, an inventory of each hotel 36 is created in the management system 2 with the criteria for room number, floor location, maximum capacity, cost, amenities, beds, view, furniture, and dates of availability. Once a room is created, the management system 2 uses the criteria to provide an accommodations director the ability to search for, and subsequently allocate, reserve or upload to on-line sales component, the entire inventory, based on any, all, or some of the criteria. Accommodations are not limited to hotels. Apartments, home shares, and condominiums, may also be included. The accommodations director may search the inventory of each accommodation and perform tasks like view room inventory details, view rooming sales and excess reports based on online sales information, block or reserve one or more rooms by client group or individual guest for a period of time; generate a reservation form and email the reservation form to the client and/or guest; and view summary of total rooms by pending reserved, confirmed and available status. The program director is allowed complete access to the entire accommodation's inventory, via a personalized login and password. Each client, with a block of rooms, is provided access to their particular allocation of rooms via a dedicated home page with individualized login and password.

The accommodations director may block or reserve each room under a particular client group based on specific requirements, protocol, contract/entitlement, budget, etc. The management system 2 can accept any number of client groups and additional groups can be added at any time including specific groups for pending on-line sales. As discussed above, once a group is created, a program manager may be assigned to specific client group, each with access to that client group's specific room block. The program manager may or may not be able to add, delete or change the block of rooms but can have the ability to view specific details for each room, assign the rooms to individual guests and rearrange the assignments of rooms within their room block. The program director may still execute control over the entire inventory and alter a room block.

Guest registration module 27 communicates with customer database 5 in order to store guest, corporate and online guest information into the system. Information ranging from arrival/departure times, accommodation preferences, dining preferences, health conditions, mobile phone number, pager, email, address, fax, languages spoken, emergency contact, passport number, among other things. Each profile may also indicate mobile device information including how to reach a guest mobile device and types of information to send to the mobile device.

The management system 2 also provides recruitment, assignment and on-site activities of program staff 28. Staff information is stored in staff inventory 48. Interested applicants may apply on-line through a recruitment web site. The directory of staffing is able to manage application and the status of the employment process via the management system 2 and the staff inventory. Upon completion of the hiring process, staff is allocated to each client based upon contract terms, specific requests (male/female, specific languages) and schedules as per the guest's movements during the program.

In live-online sales 30, selected inventory can be immediately available for sales in a “pending mode.” The inventory database 4 stores hospitality packages that may be sold on an individual basis apart from a client hospitality program. Sales prices may be set and an individual guests 17 can see the amenities for a particular accommodation and can select the dates of their stay. Once the purchaser selects a room, they have a time limit to complete the transaction before the room is released back into available inventory. After a purchase is finalized a confirmation email detailing the accommodation type, length of stay and the full purchase price is sent to the individual guest 17 with a copy also sent to the program director. The management system 2 may update the room status from pending to confirmed, inserts the sale price and name of the guest(s) along with the confirmation number so the sale can be tracked and reported. Based on the inventory information, an accommodation inventory report may be created listing the rooms by property, available, pending, reserved and sold status, and inventory total cost vs. total sales revenue. Reports may be exported to various application files including but not limited to, Microsoft Excel, Microsoft Word, or PDF format.

Passes to hospitality centers 46 may be sold to individual guests 17 and groups 10 and provide access to the hospitality on a daily basis. The inventory of available passes 46 is entered into the management system 2 and upon sale of a daily pass to either a group or individual, the pass is removed from available inventory and allocated to the purchaser(s). This allocation provides the food and beverages director the ability to track the number of visitors each day and subsequently the quantity of food, beverage and staff desired. In addition, the system generates reports on sales of the passes and excess inventory.

Another inventory item is transportation 44, which is managed through transportation management component 32. The available inventory of vehicles may be loaded into the management system 2 from which a transportation director can assign vehicles and drivers to a client hospitality programs. Type of vehicles to be used for each client hospitality program may be determined by contract terms and the specific daily schedule determined by a program schedule. The transportation director may monitor the utilization of each vehicle via the program schedules. A complete range of reports including usage for each vehicle and driver may be created. In an alternative embodiment, if a client or program manager has the need for a transfer that is not accommodated by the vehicles assigned to their program, a real-time request may be submitted through the management system 2 during on site execution for additional transfer transportation. The request may be received by the transportation director via the management system 2 and reviewed for available inventory to fulfill the request. As a reply, the vehicle, driver name and driver contact number of who has been assigned to the transfer may be updated in the management system 2 and alert sent to the client regarding the updated information.

Once the program schedules are determined for each client group, a food and beverages director is able to view available meal times (breakfast, lunches, and dinners) associated with each program. A food and beverages management department 34 enables the food and beverages director to coordinate with the food and beverages inventory 42. Arrangements may be made for meals based on clients budget, location, diet restrictions, and other preferences. Accordingly, each meal is arranged for based on type, location, and/or number of total meals. Full catering reports may be available within the system for meals by client, location, and/or meal period complete with cost pricing for the meals and comparisons to budgets.

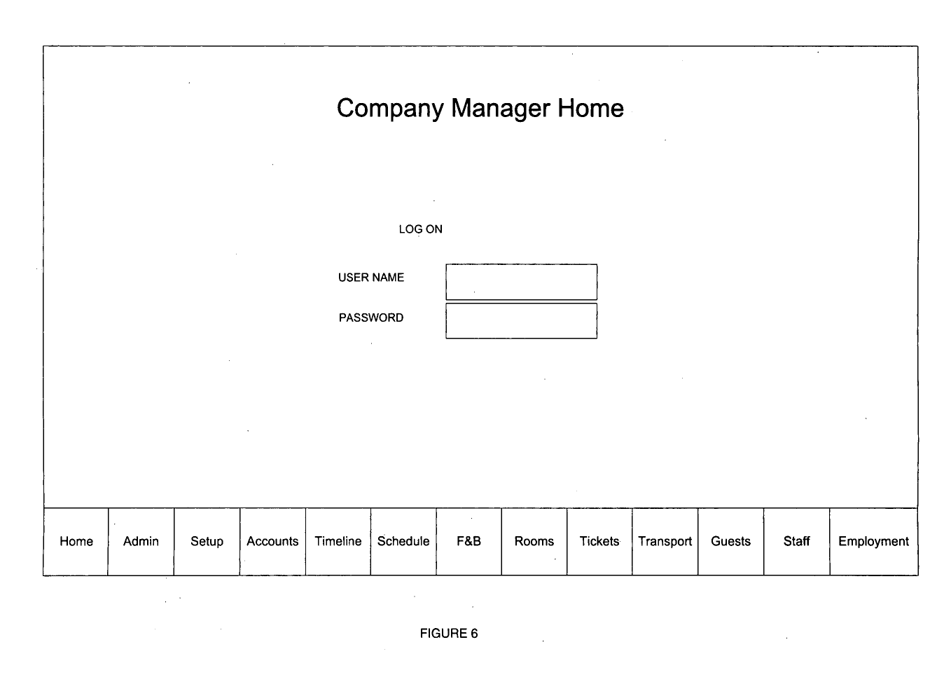

A program manager may access the management system through the communications module 33 in order manage each client program. The following is a description of the management capabilities offered to a program manager through the user interface module 31 of the management system 2. Using a special login and password, the program manager may access various aspects of the management system through a series of user interfaces, described in connection to FIGS. 6, 7, 8a-8d, 9a-9f, 10a-10g, 11a-11i, 12a-12f, 13a-13d, and 14a-14f.

As depicted in FIG. 6, a program manager home page may be provided to facilitate various functions. For example, the home page may enable a program manager (or other authorized personnel) to access management modules for: administration, setup, account, timeline, schedule, food & beverage, rooms, tickets, transportation, guests, staff, and employment. . Additionally, a proposals module may be provided as well.

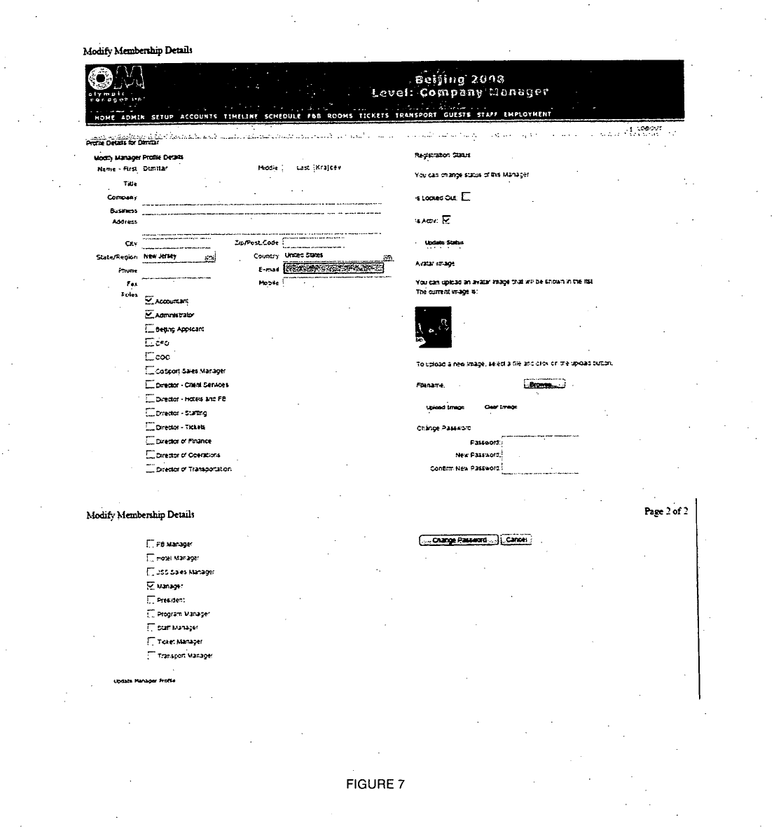

FIG. 7 depicts a administration user interface that allows an internal participant (e.g., program manager) to be assigned to a client and/or group. The assignment may reflect the various limitation that a program manager can operate under. The interface may show

A setup link may allow various setting to be customized including but not limited to user interface views. The accounts link may be a management module which allows one or more client groups to be managed with respect various elements including cost breakdown, budgeting, additional purchases, and/or billing and invoicing. These elements may also interface with various other management modules in order to provide accurate budget forecasts.

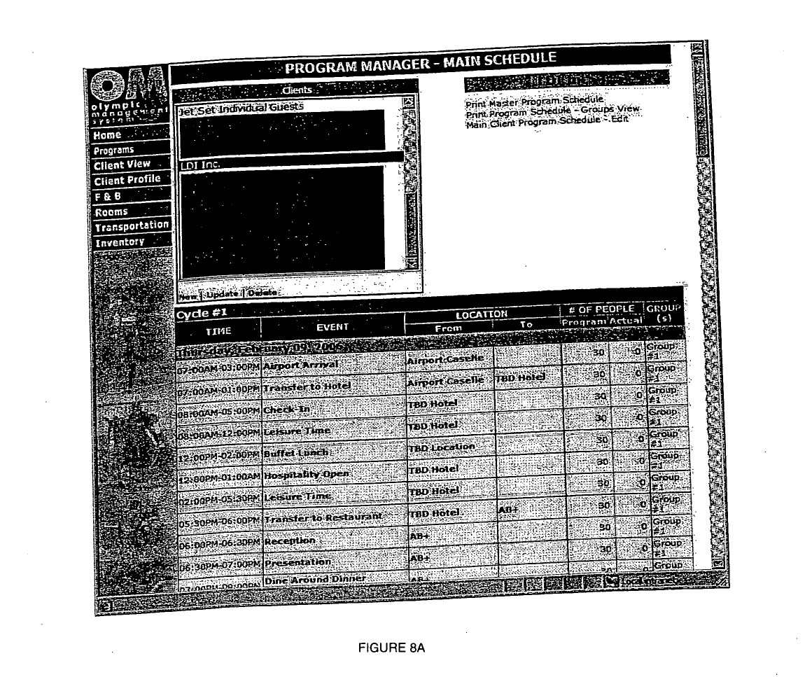

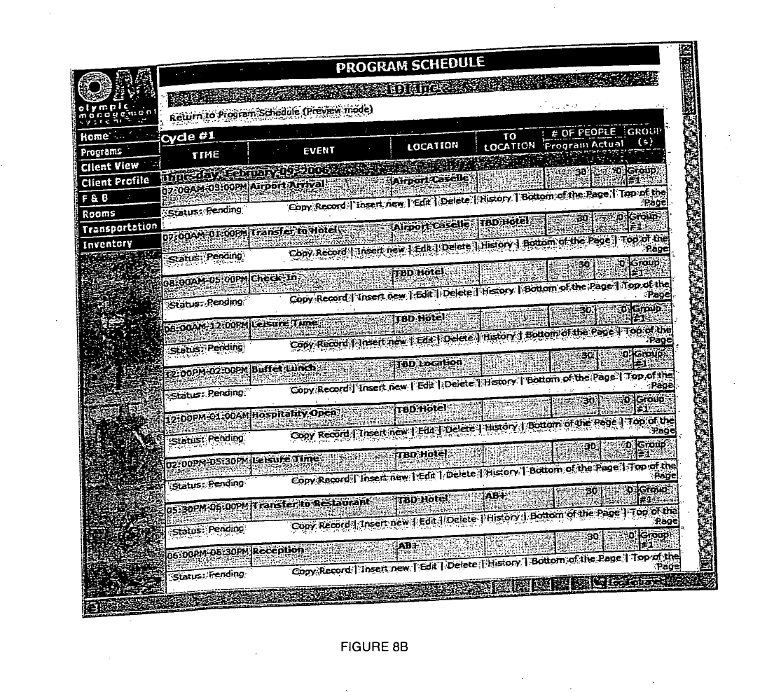

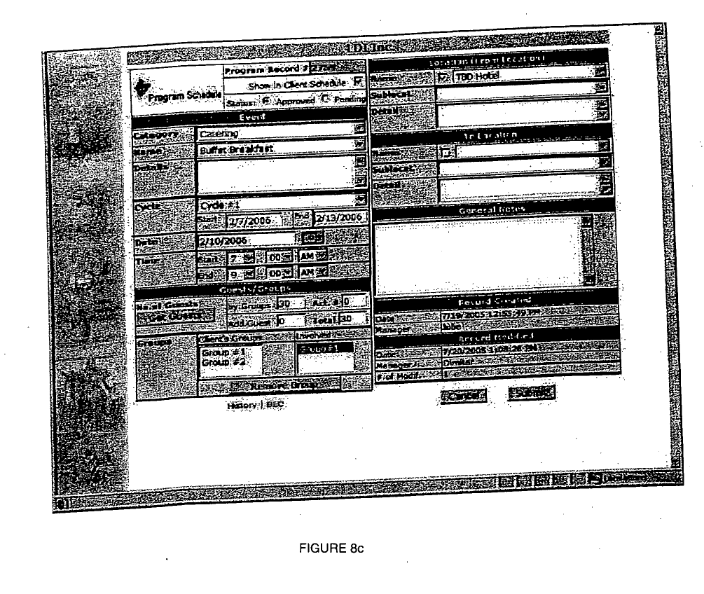

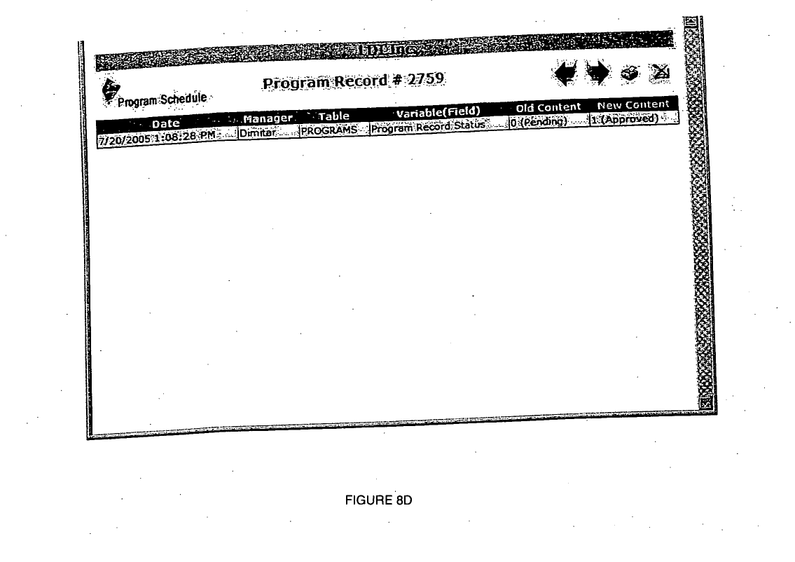

A timeline management module may include scheduling activities to be performed by internal participants during pre-event, on-site and post event periods. A program manager (or other manager) may track execution (among other things) of the event. FIGS. 8a-8d depict various aspects of the user interface that is displayed when a program manager selects “fill in”, for example, various options enable the program manager to view a main schedule, a program schedule in preview mode, a main program schedule with a record edit option, and a main schedule program with a history of changes. Program managers (and group coordinators) may be provided with a “day at a glance” schedule and/or summary view. A day at a glance may map out the events of the day. A summary view may show program schedule events for all accounts managed by the same program manager (or other participant).

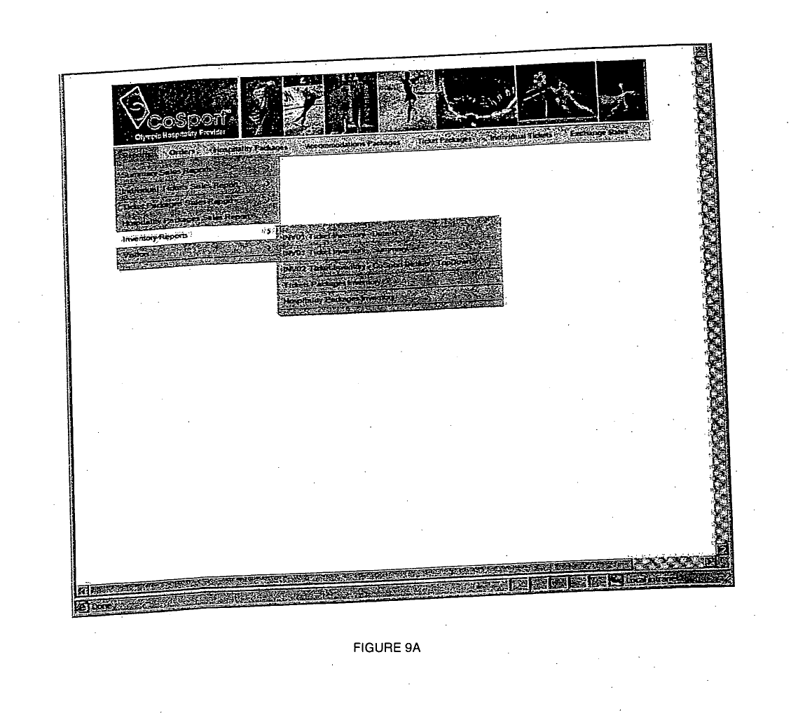

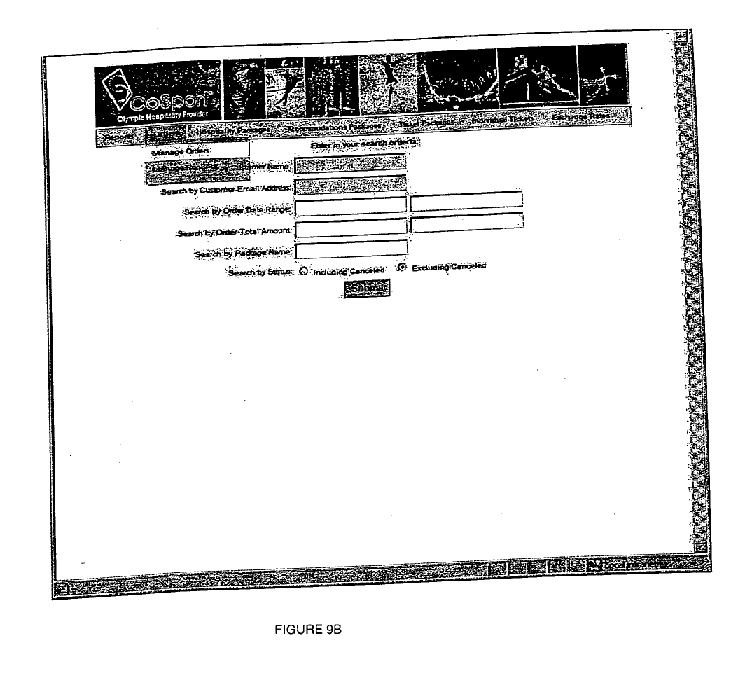

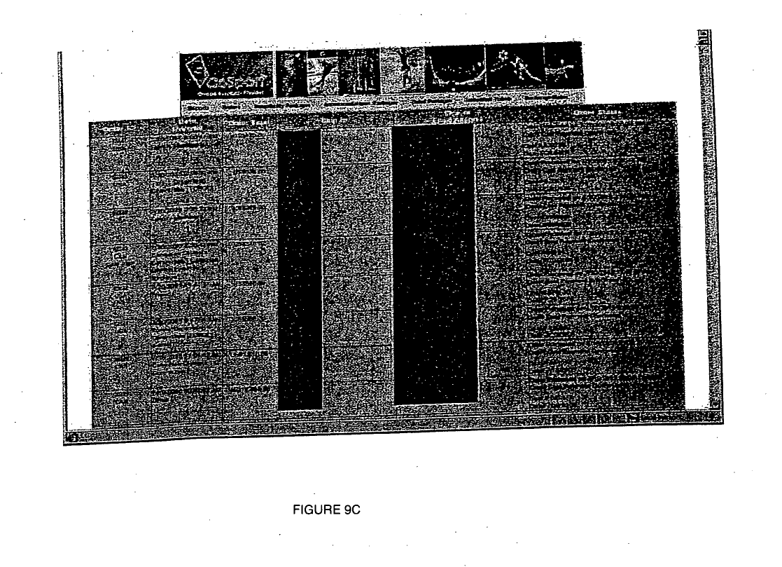

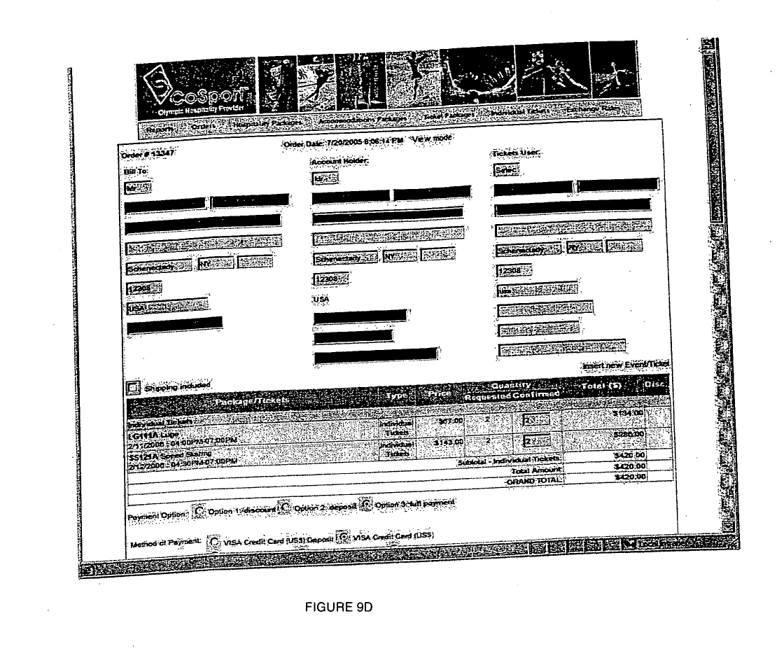

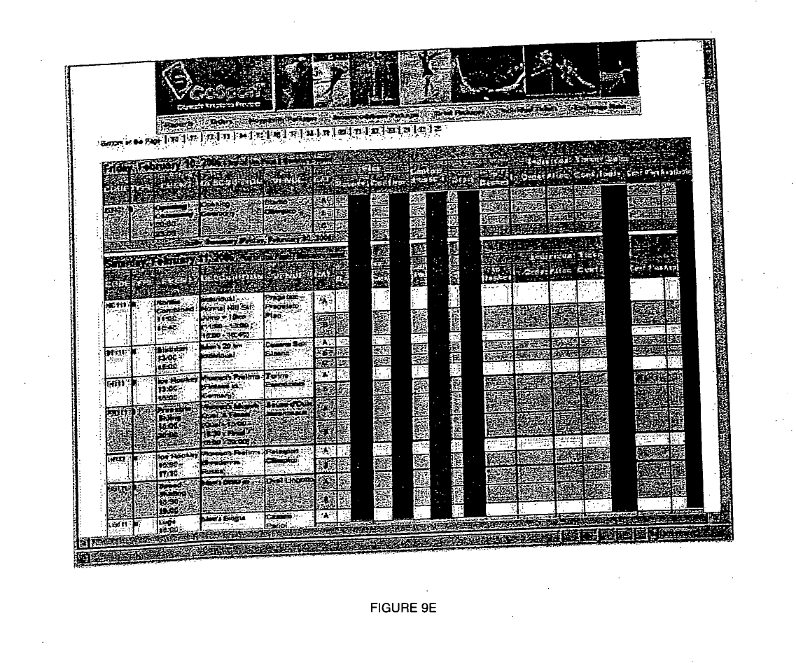

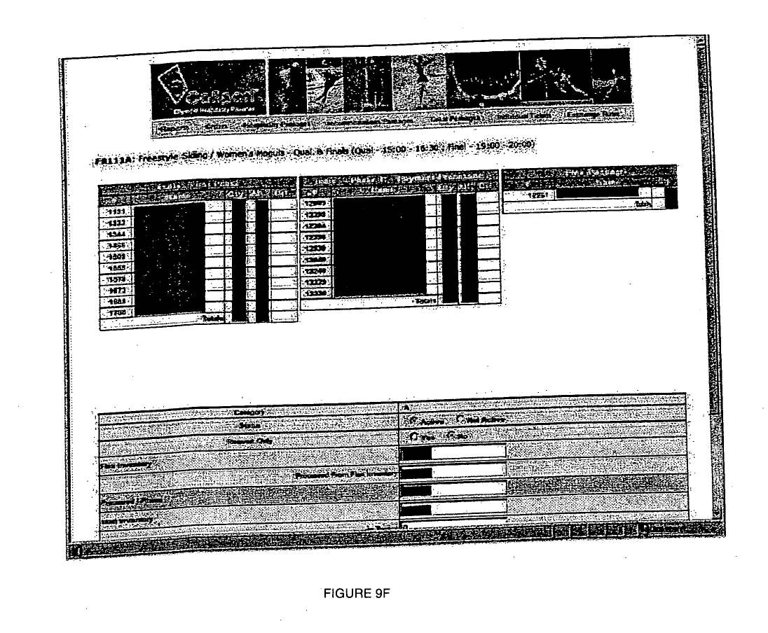

FIGS. 9a-9f depicts various aspects of the on-line sales interface module of this system. The on-line sales manager home page may enable a user to select from among various options including reports, orders, hospitality packages, accommodation packages, ticket packages, individual tickets, exchange rates and/or other options. As depicted in A12a, if the reports menu is selected, various other options may be provided. Other user interfaces and aspects may be available.

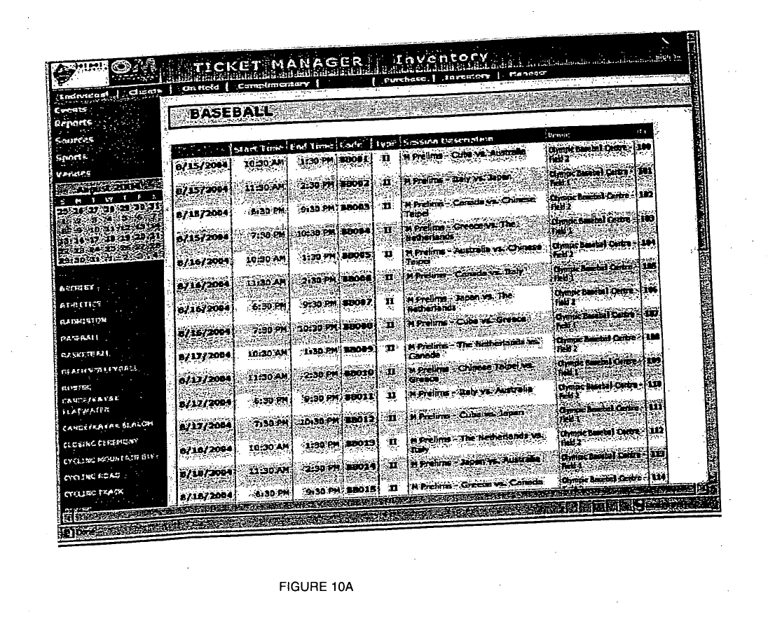

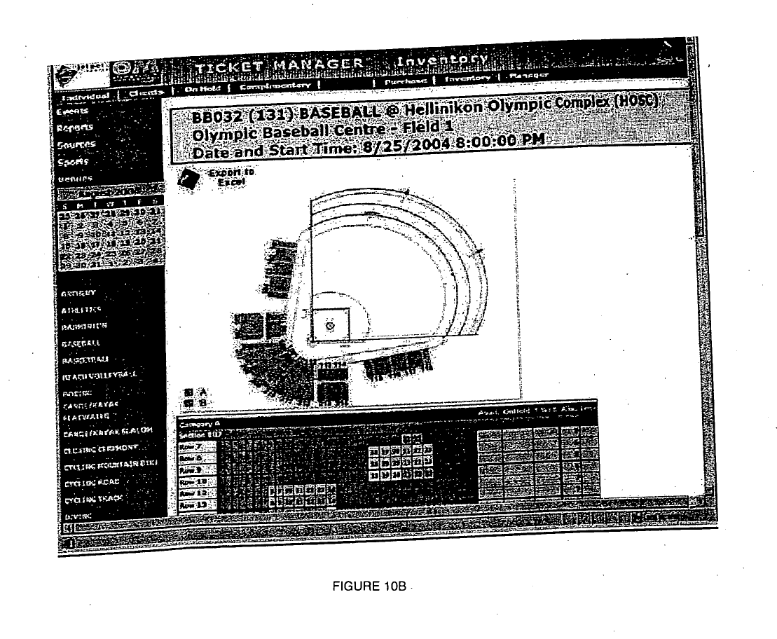

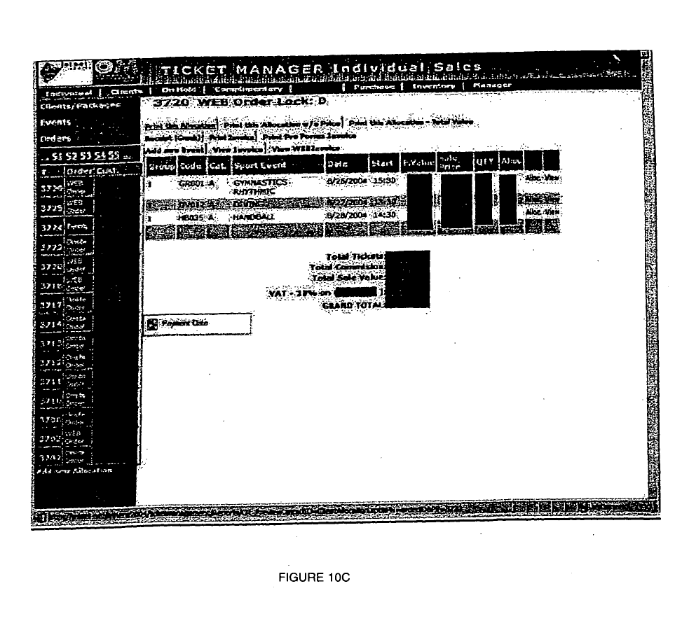

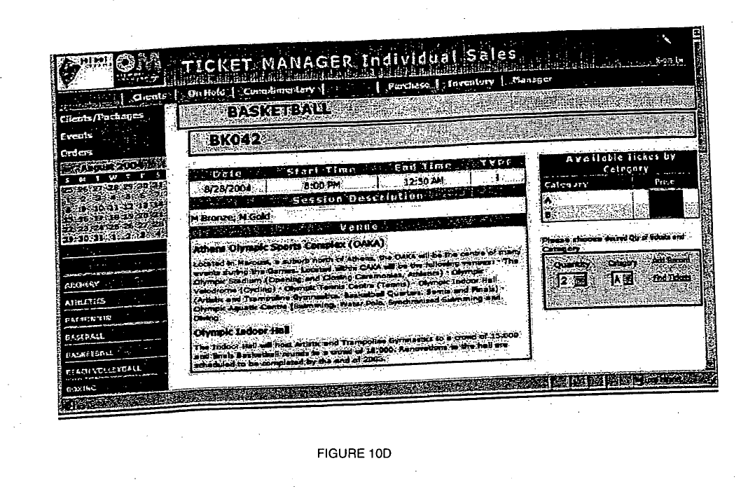

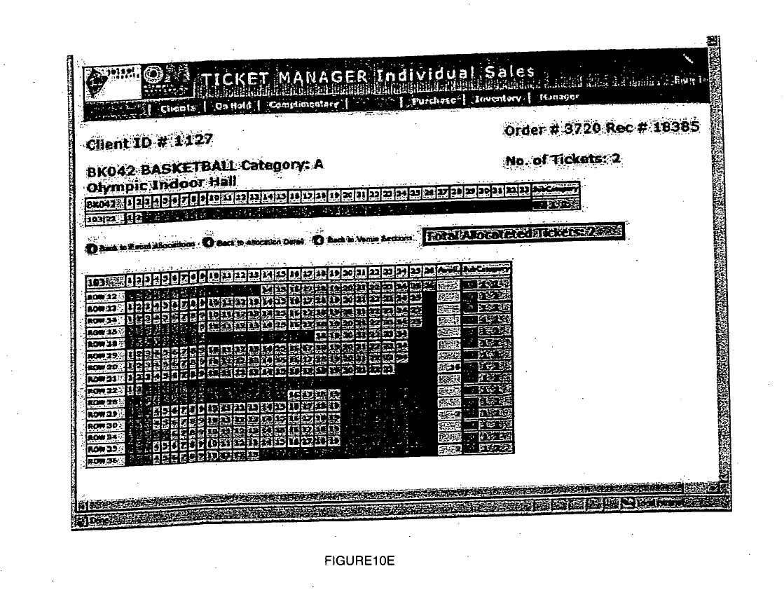

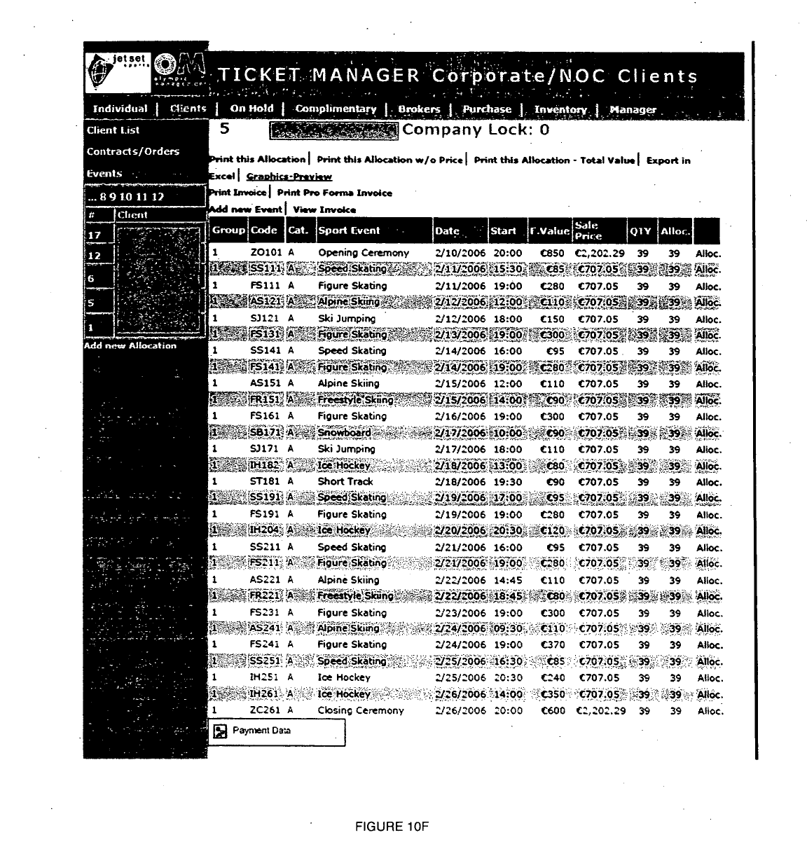

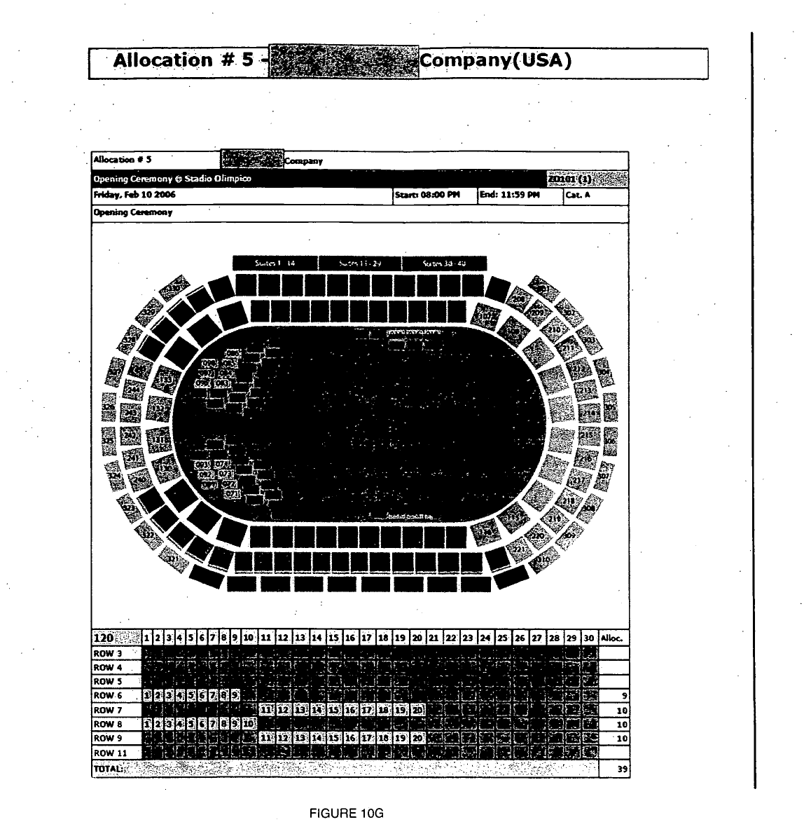

FIG. 10a-10g display an example of a ticket management inventory interface. This set of user interface screens enables a user to select from among different events, reports, sources, sports and venues, among other things. As shown for example for a given sport, the user interface may display one or more of the date of the event, the projected start time and end time, one or more codes and types, session description information, and/or venue information. If desired, the system may also display a seating charge to coordinate the existing tickets and the status (for example, available, not available, assigned, not assigned). Different screens may be displayed for individual sales and/or group sales. For example, FIGS. 10a and 10b disclose aspects of managing ticket inventory. FIGS. 10c-10e disclose managing aspects of individual ticket sales. FIGS. 10f and 10g disclose aspects of managing group (e.g., corporate client) ticket allocations.

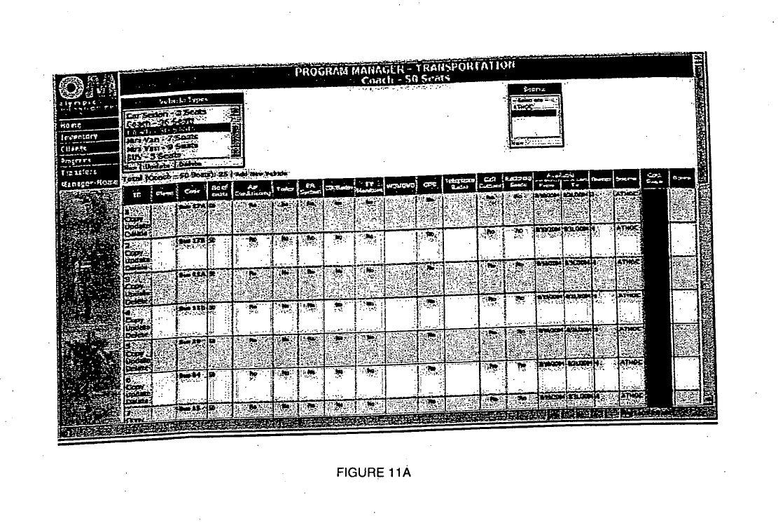

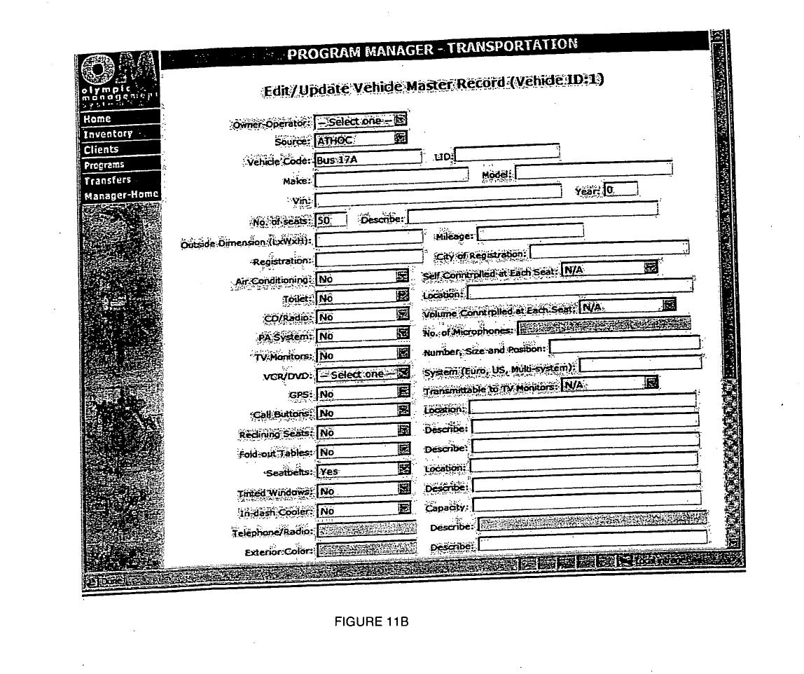

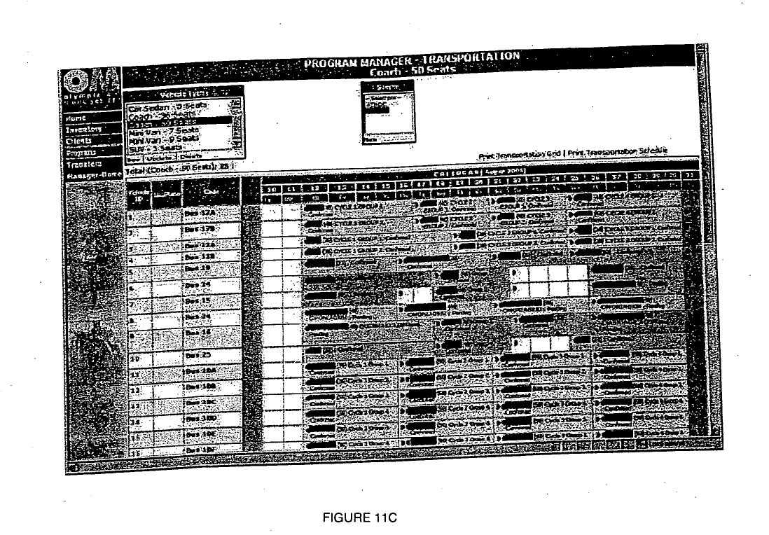

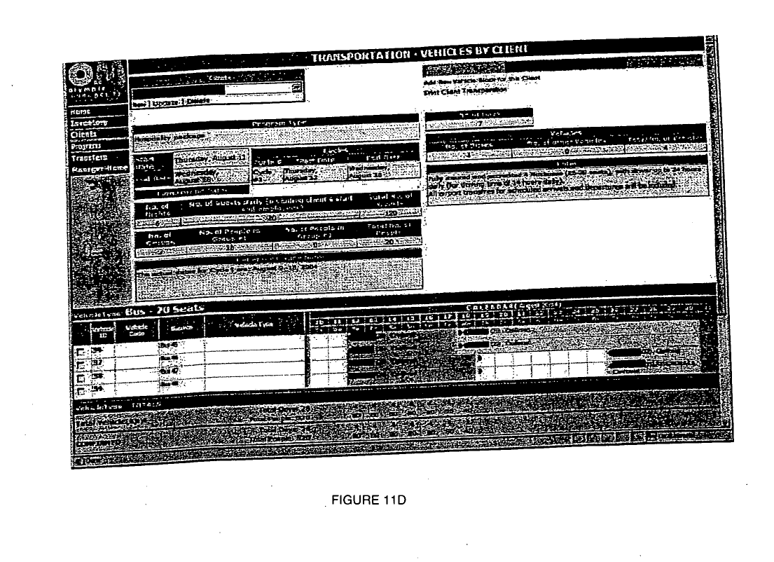

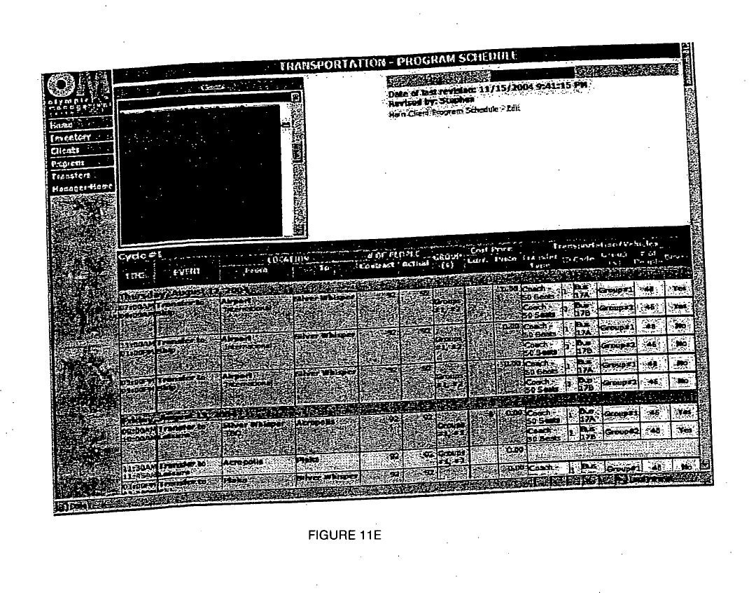

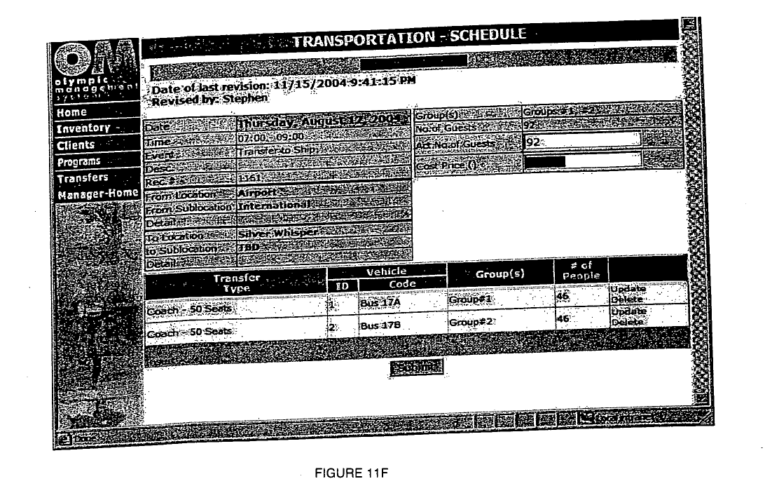

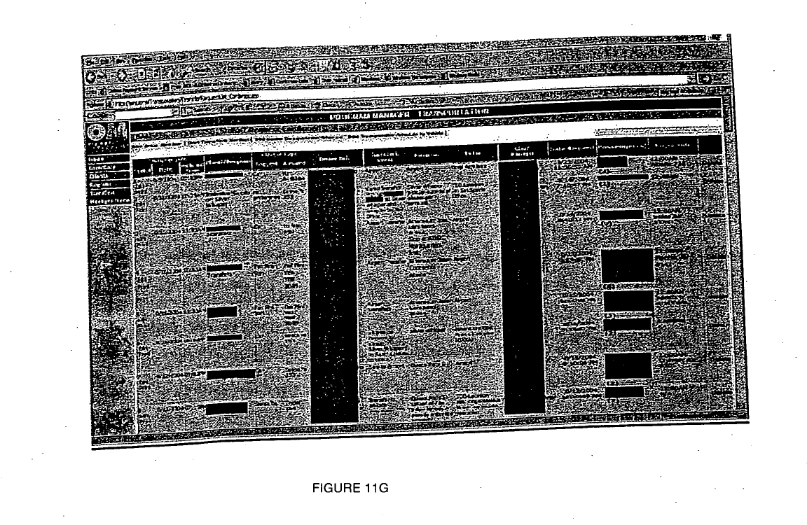

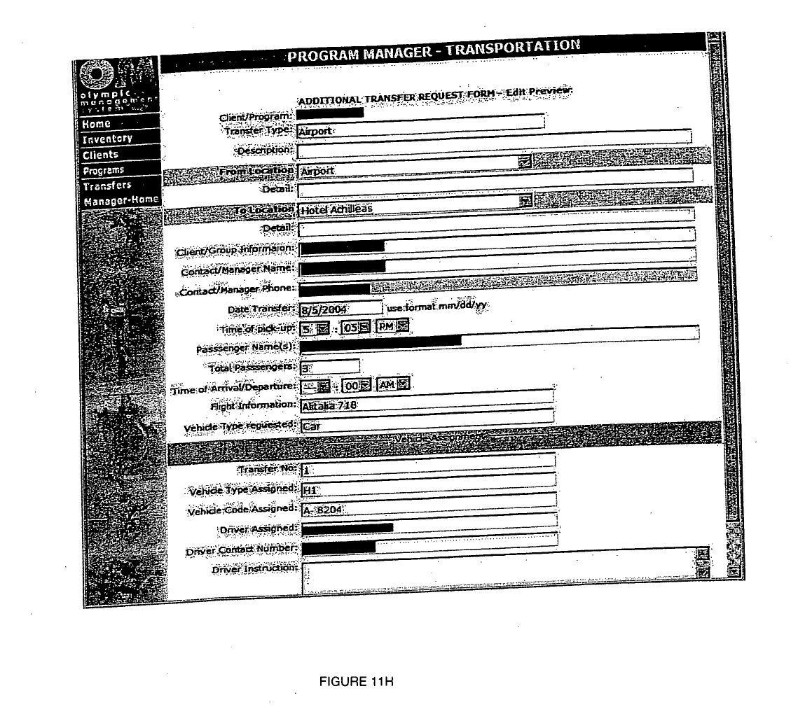

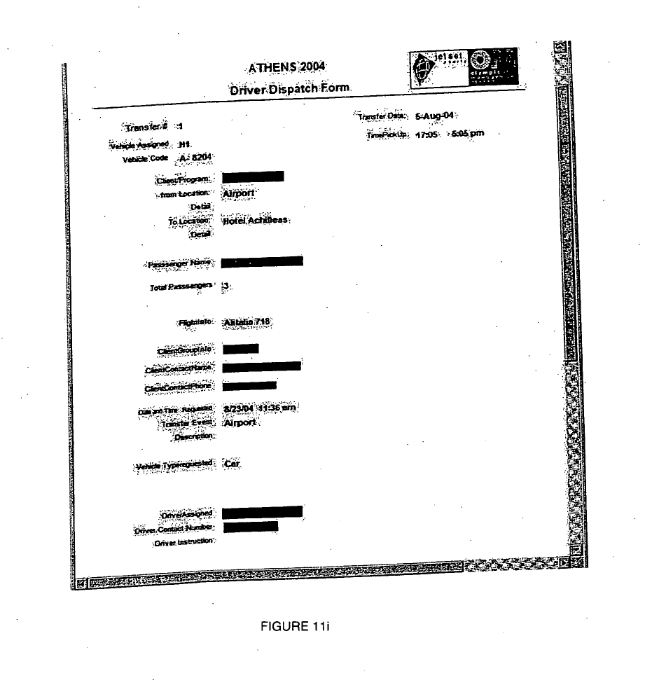

FIGS. 11a-11i display a set of screen shots that provide examples of the user interface that may be used in connection with the transportation module. This set of program manager user interfaces allows a vehicle type to be selected from a third party participant and the fleet of vehicles that fit the vehicle, type. New vehicles may be added, an update vehicle master record may be edited. A vehicle may be assigned to a driver(s) and their timelines may be created for corresponding events. A calendar view allows program manager to view the allocation of vehicles and drivers by day and time to clients, or vehicle allocation may be viewed by client. A particular client's program schedule may be viewed with respect to transportation schedules only with the option to view each scheduled transport separately. A transfer request list may be viewed and edited wherein a driver dispatch form may be filled out to request additional transportation.

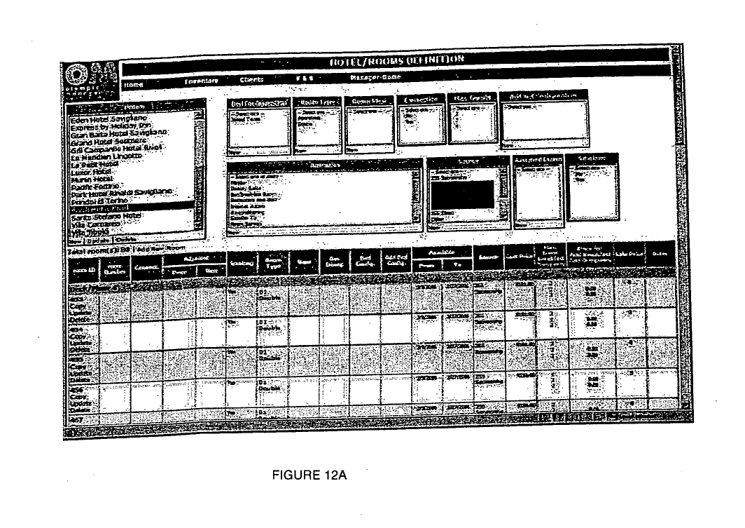

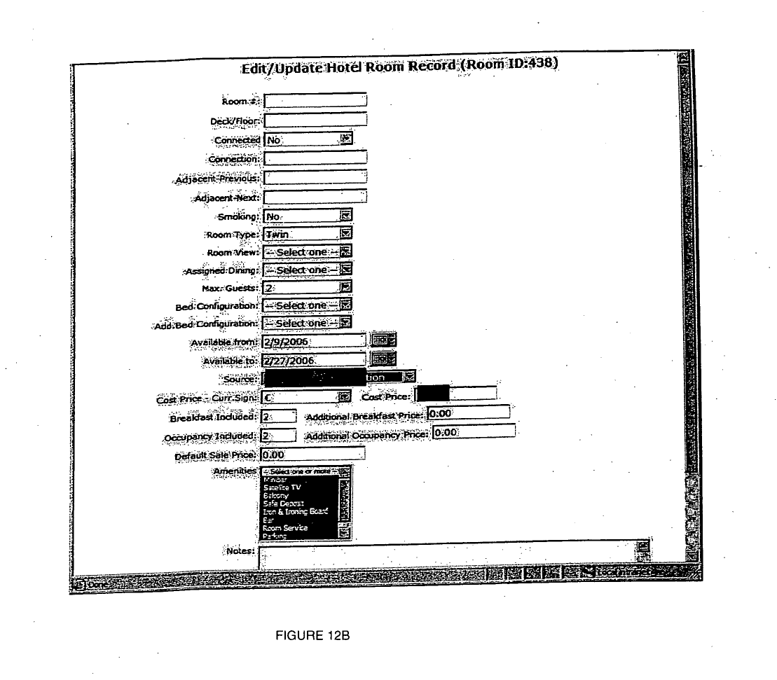

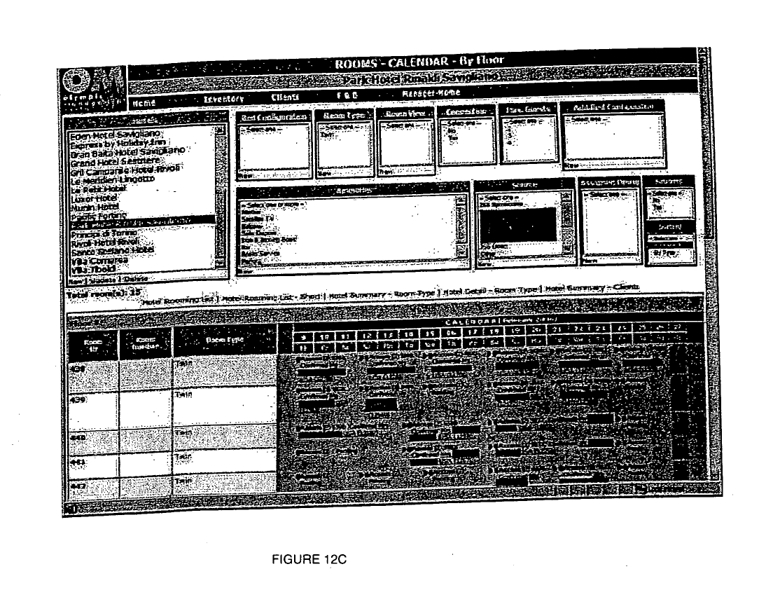

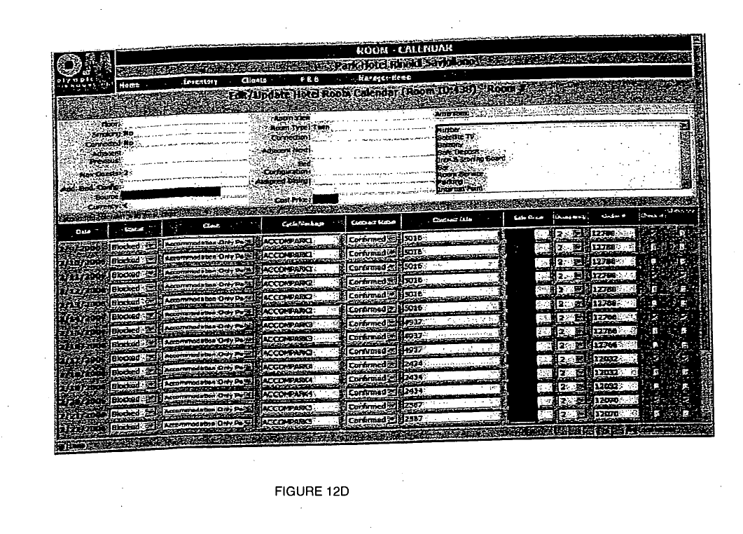

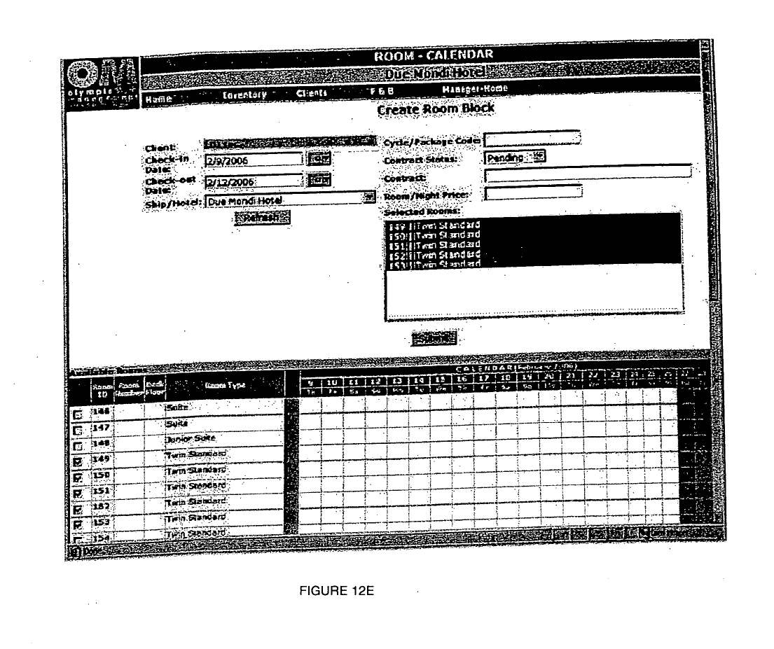

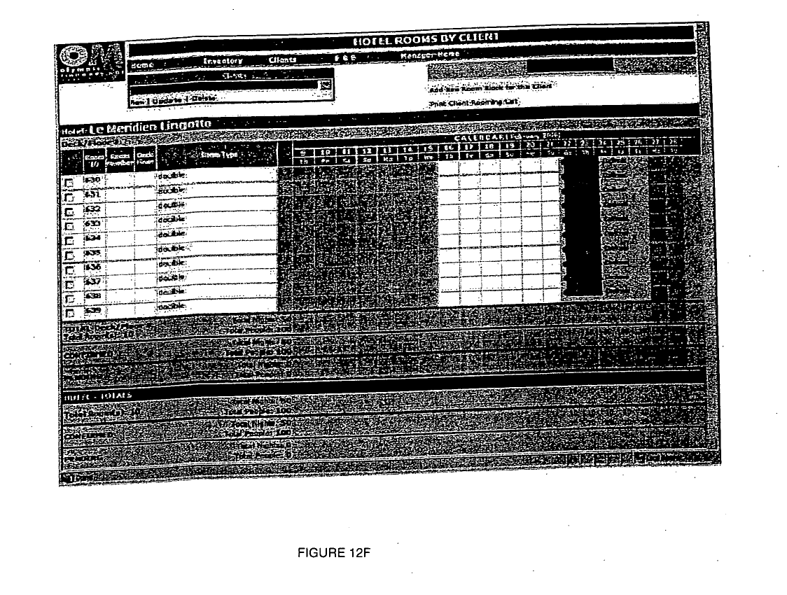

FIGS. 12a-12f depict various screen shots that may be used in connection with the accommodations module of the system. Accommodations may be viewed as inventory and edited to add more inventory. A room record is created for each accommodation room. Accommodation information may be viewed and edited in calendar view, room block and rooming list. Hotel managers may also access parts of the of the accommodations module in order to track hotel guests and hotel rooms, room blocking, proposals and invoicing.

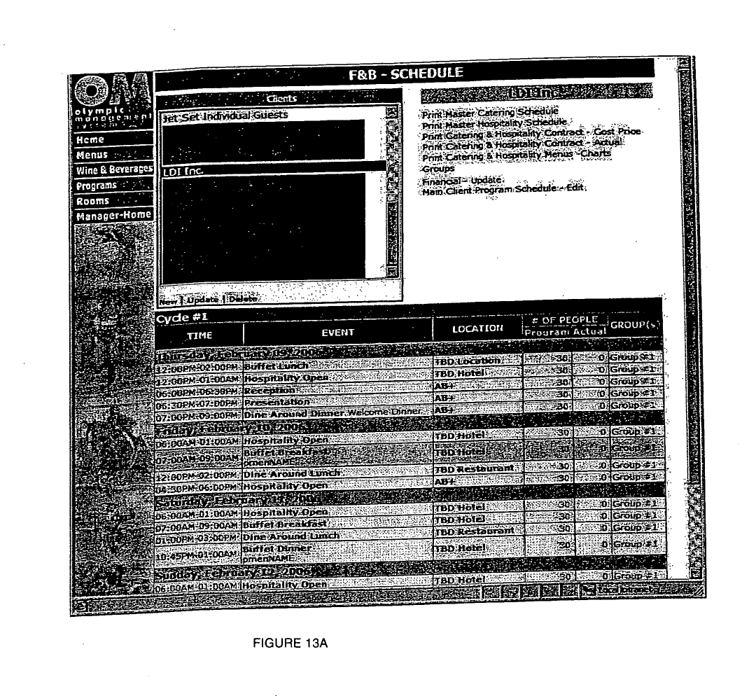

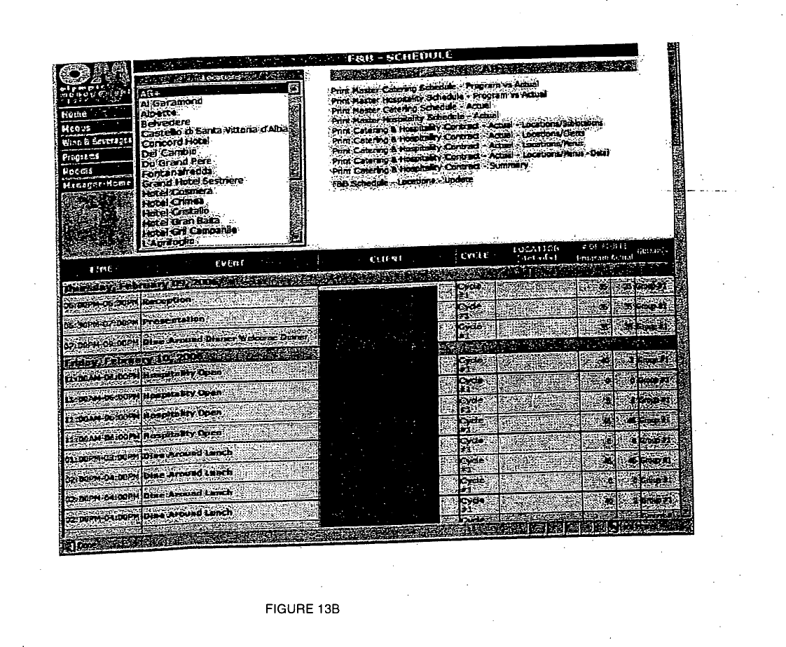

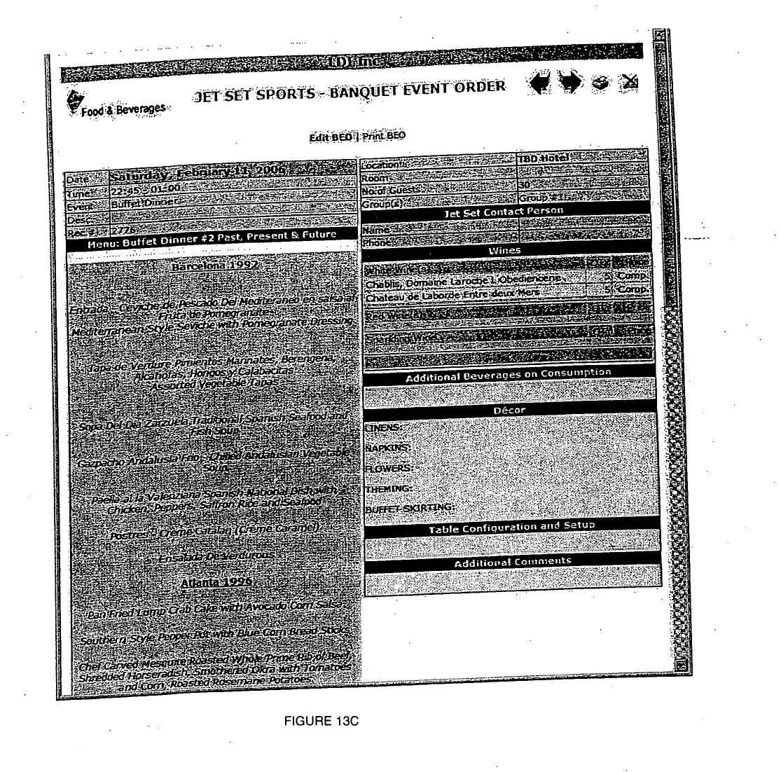

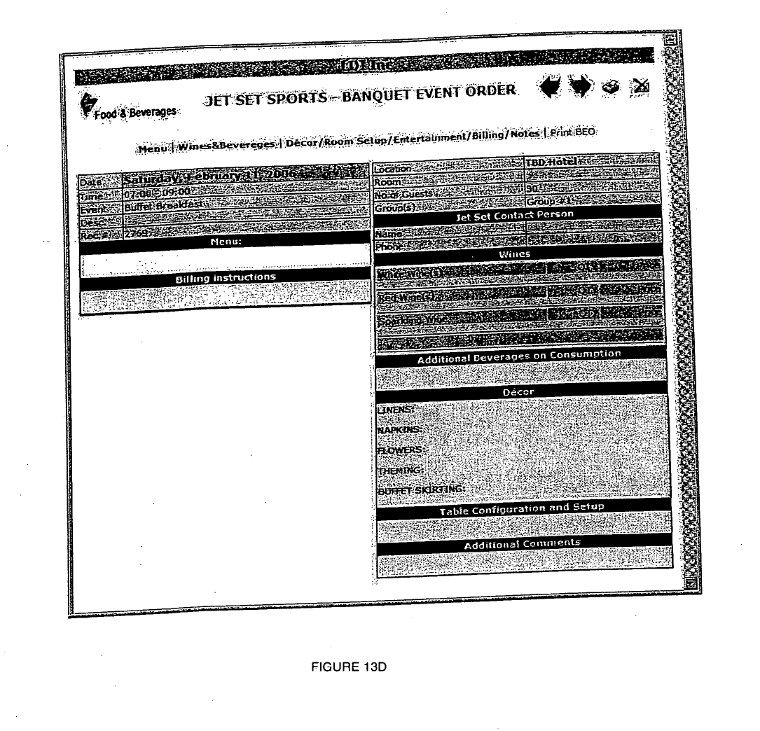

FIGS. 13a-13d depict various screen shots that may be used in conjunction with the food and beverages module of the system. A food and beverage schedule may be created including the options to print master catering schedule, master hospitality schedule, catering and hospitality contract by cost price. Meals may be planned using Banquet Event Orders which may be edited to include menu items, guest dietary restrictions, decor, beverage selection, contact person, location, billing information, and contact person. A glossary of food terms may be provided. Such information may be provided to guests who are unfamiliar with the cuisine served in the location of the event.

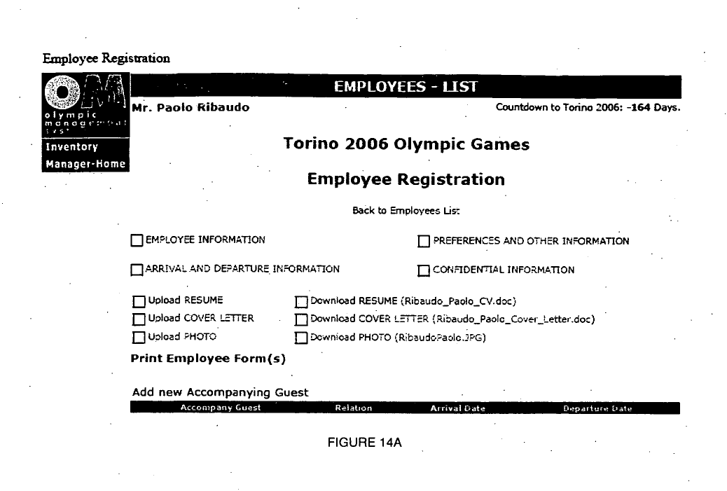

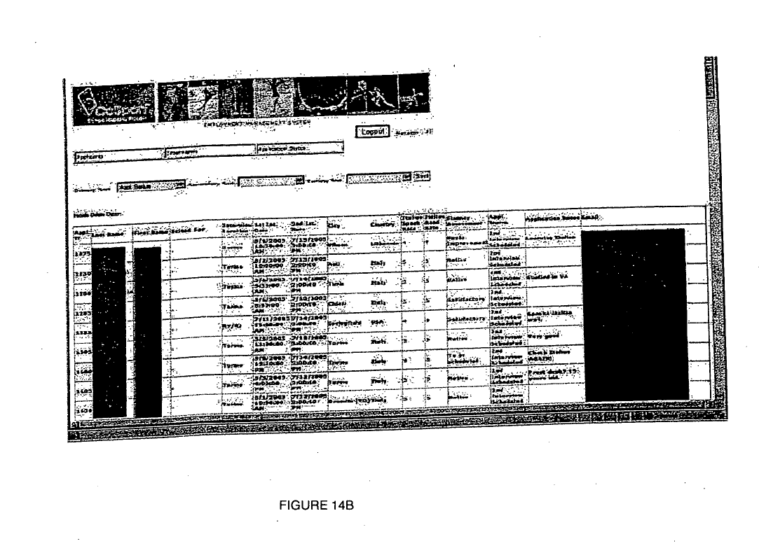

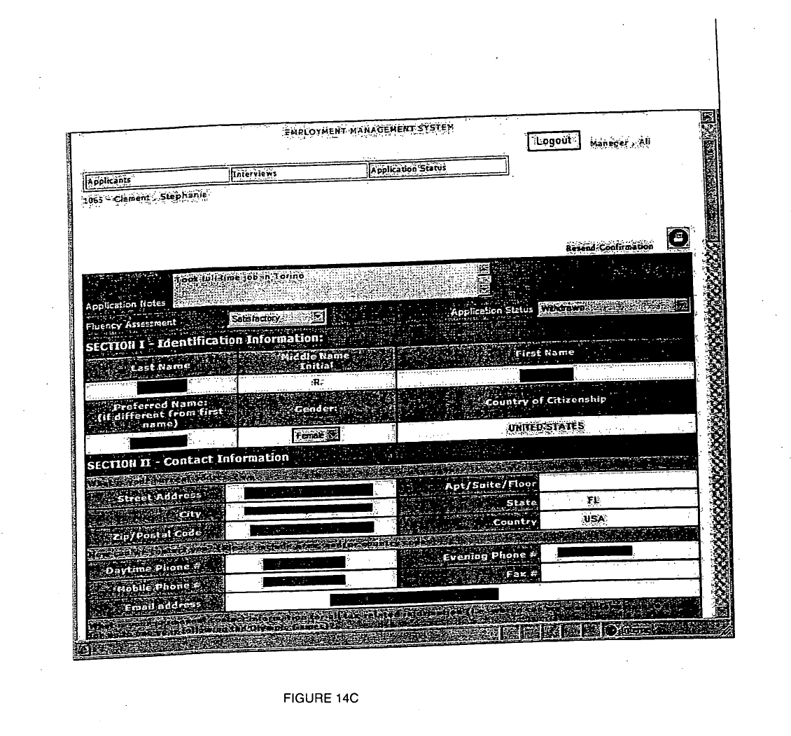

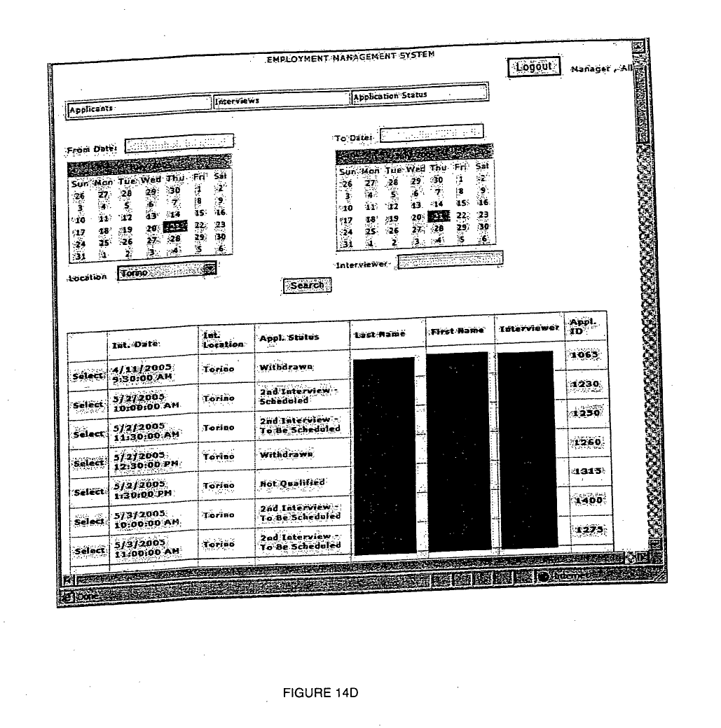

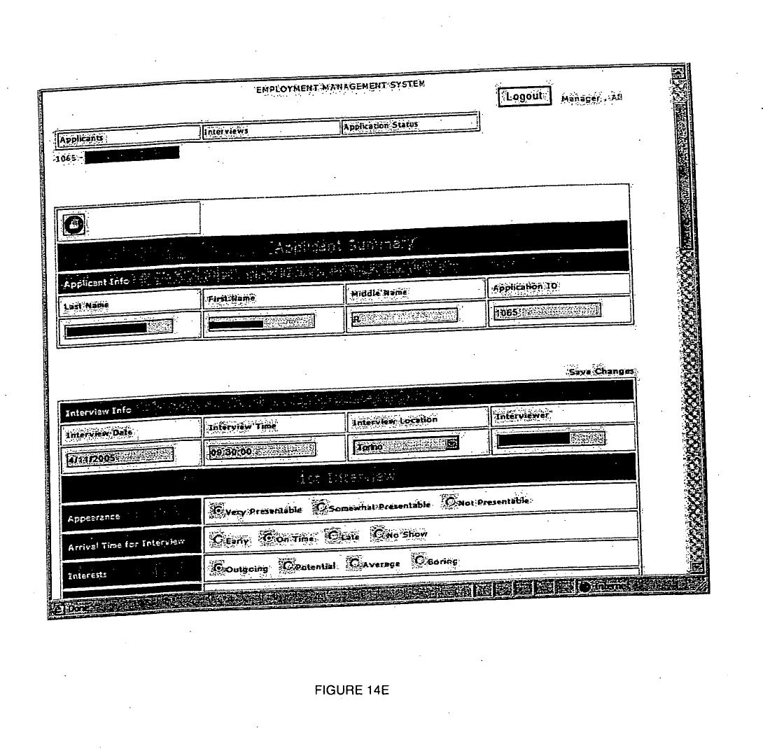

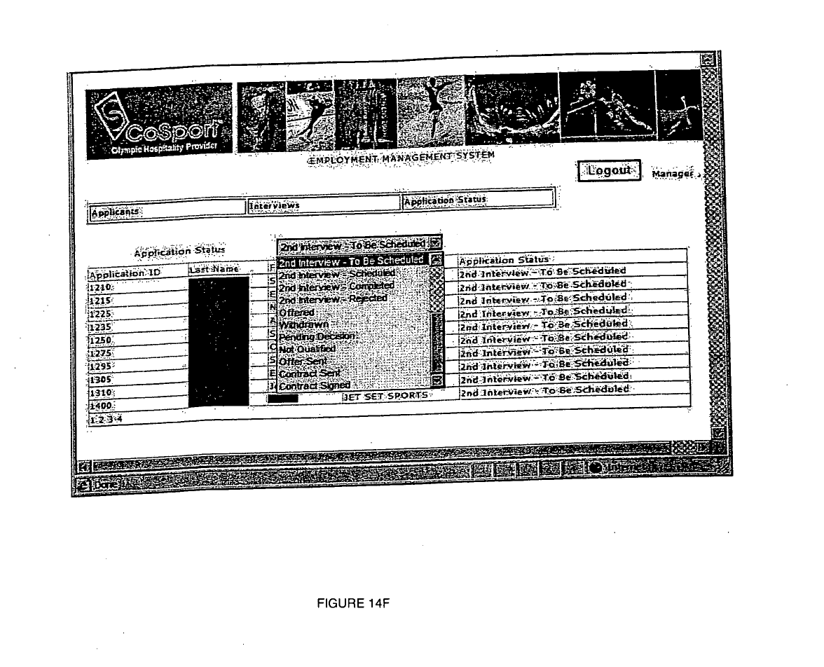

FIGS. 14a-14f depict various screen shots that may be used in connection with the employment module of the system. Employment user interface allows a hiring director to view application information from applicants by name, dates available, country, language, and email. Several employees may be organized within an employee list. For each employee, a resume, cover letter and photo may be uploaded to and downloaded from the management system. Employees may be selected by the skills listed in their resumes. Once the term of employment has ended (at the end of the event), employee information may be stored within a database of other employee information to be reused for future events (e.g., recruiting). The user interfaces allow applicants' information to be stored and searched by interview schedule, application status, and applicant summary.

A guests management module provides information relating to all guests and their respective groups and/or client affiliation(s). Similarly, the staff management module provides a information relating to all staff and their respective responsibilities. This information may be use to extend reporting abilities related to guests, client's group and their daily schedule, events per venue/location, transportation and other hospitality items.

Hospitality Program

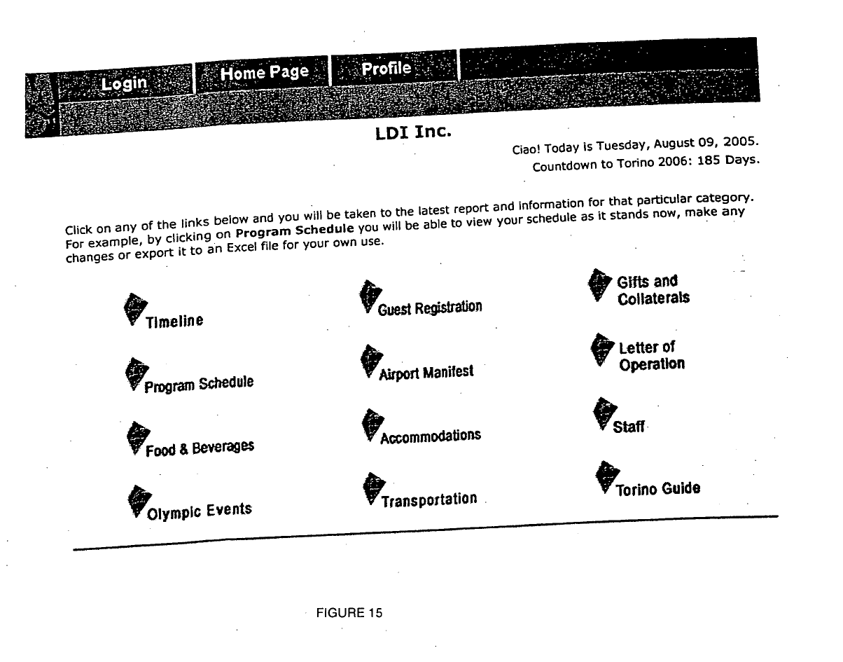

FIG. 15 is a menu demonstrating the various features of the hospitality program that may be accessed from the by the client 10, including program timeline, program schedule, accommodations, food and beverages, transportation, event tickets, guest registrations, airport information, gifts, staff, letters of operation and a city guide. A client may accesses the management system 2 using special login and password in order to view registered guests and their hospitality program schedule. Each client guest may also access parts of the management system 2 through the Internet or an Extranet in order to enter guest registration information as a new guest or an existing guest. Guest registration allows guest information, preferences, airline itinerary, and profile information to be entered and updated.

A client may access their client hospitality program via the web based management system 2 from any computer, providing the capability of real-time updates, changes and reporting. A user interface module allows group coordinator and guest access to customized web sites 25. Each client group is established in the management system 2 as individual programs and thus provided a dedicated web page within the management system 2 for reporting client hospitality program information. The program timeline is a complete program planning timeline established for each client. Included in the timeline may be the components and action items desired to insure the success of the event hospitality program. Each action item is categorized (e.g., air transportation, ticket allocation, budget/billing, etc.) and assigned a target completion date. As the programs progress the timeline is continually updated noting any additional items and current status.

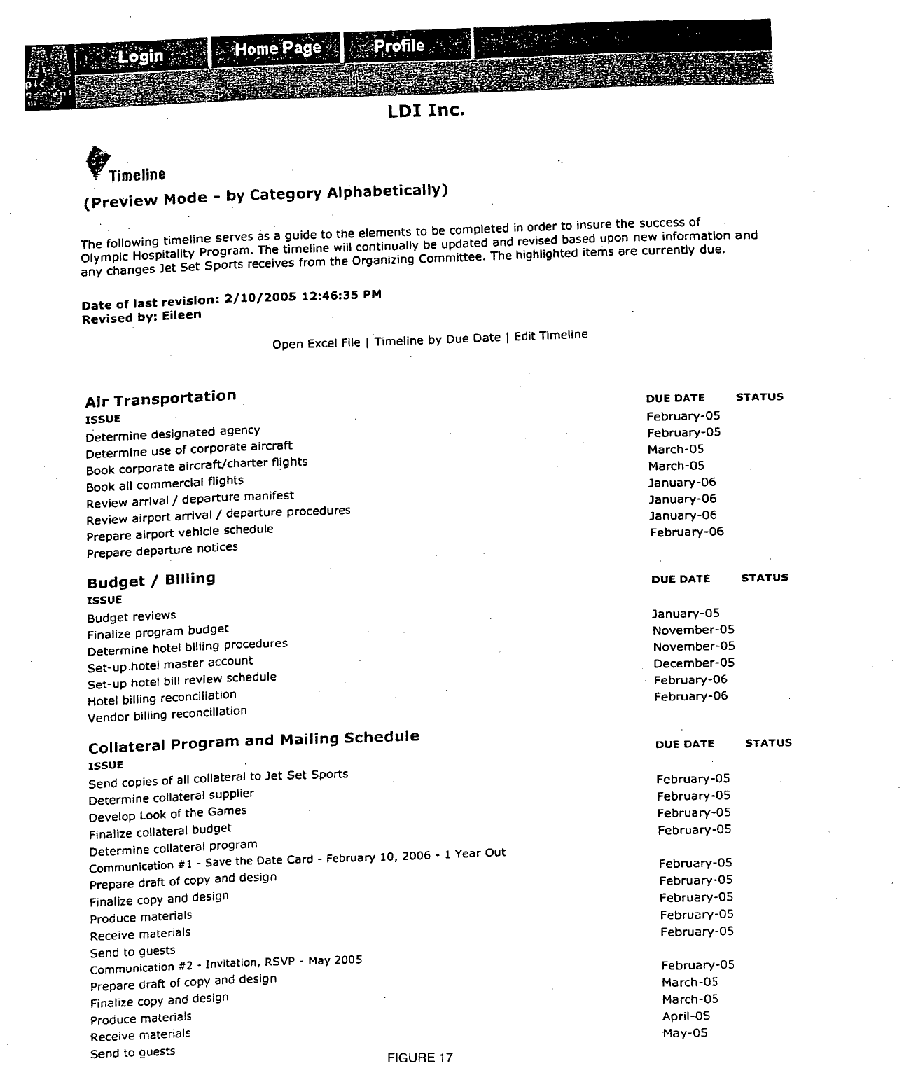

The timeline mode can be displayed by category or by due date. As shown, for example, in FIG. 17, when shown in category view, the user interface displays the category, a list of issues pertaining to that category, the due date for each issue, and a status field. When the timeline is displayed in preview mode by due date, the user interface may display on a monthly basis categories and issues within that category with an appropriate due date and a status field.

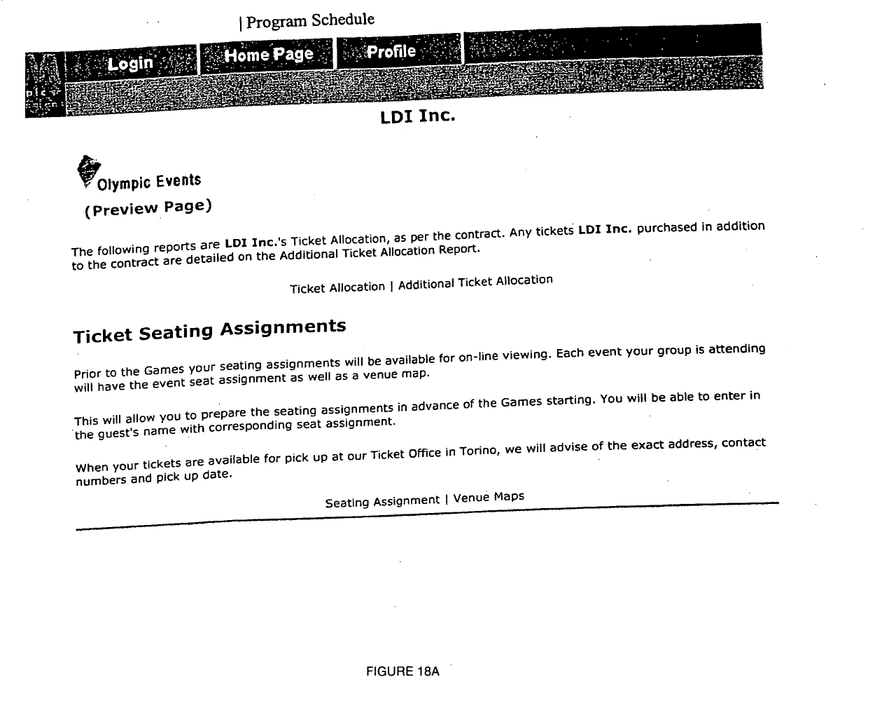

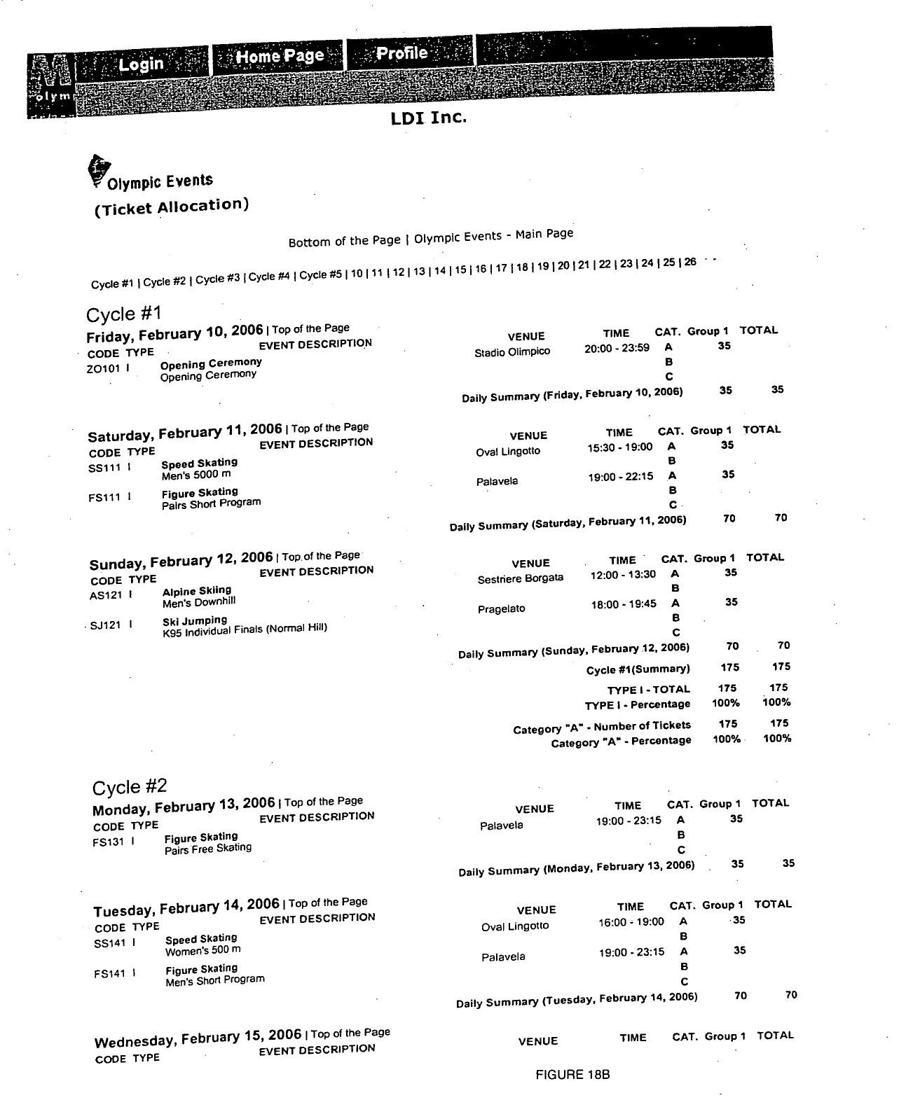

Returning again to the main screen, the Olympic events option enables a user to display ticket information for a particular Olympic event as shown in FIG. 18a. Selecting this option causes a display from which a user can select a ticket allocation screen depicted, for example, in FIG. 18b or an additional ticket allocation option, which allows guest to purchase or request additional tickets. Additionally, from this screen, a user may view and manage ticket seating assignments. The ticket seating assignment may include a seating chart of the stadium or other venue in which the event is being hosted, with a seating chart and an indication of the seats available and assigned to the group and/or individual members.

Event information addresses the ticket allocations including type of event, seating category, number of events and number of guests at each event. Prior to the event the client seating assignments may be available for on-line viewing. Each event to be attended will have the event seat assignment information as well as a venue map. The ticket allocation forms the backbone of the program schedule with respect to transportation, meals, leisure time and/or any other events scheduled around the event.

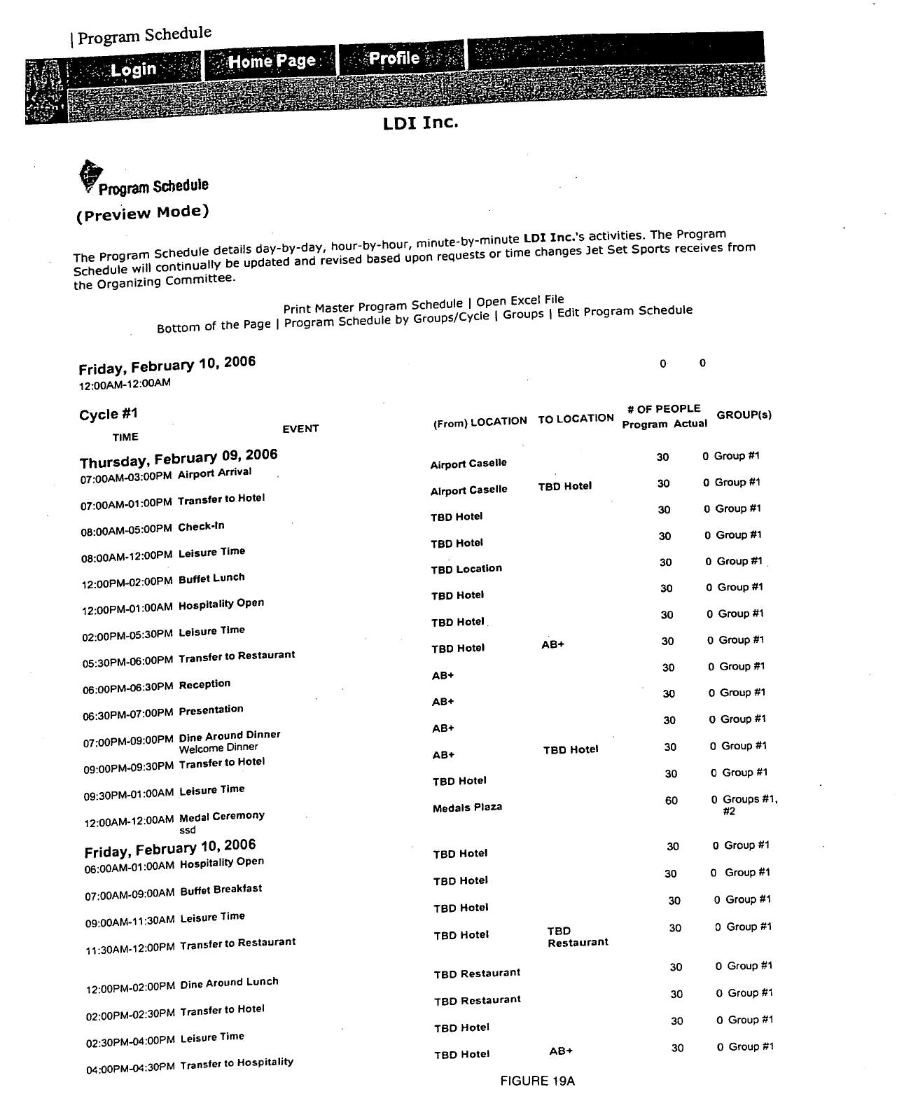

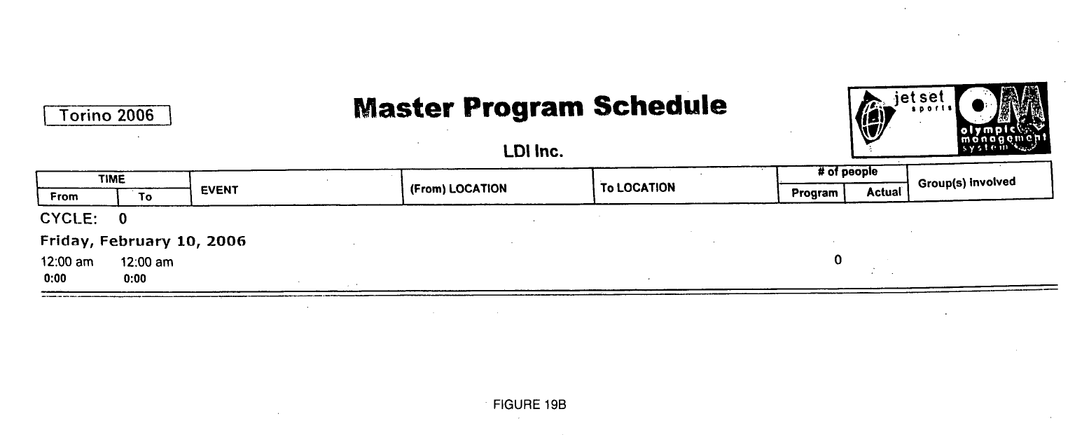

Returning again to the main screen, the user can select a program schedule option. Doing so displays the user interface depicted, for example, in FIG. 19a. From this screen, the user can also print a master program schedule shown, for example, in FIG. 19b. Additionally, the user can print a program schedule by groups/cycle. Cycle may include the dates of the event for which the guest will be partaking in program schedule. Additionally, an authorized user may edit the program schedule by selecting the edit program schedule option. Additionally, the user can elect to select the program schedule view by groups option which displays the user interface depicted, for example, in FIG. 19a. The guest may also have the option to download their part of the program schedule as a file (e.g., iCalendar, outlook appointment, etc.) from the user interface.

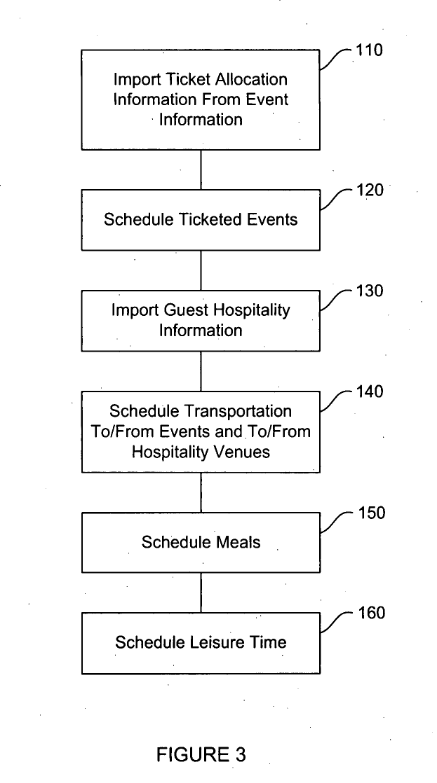

Turning to FIG. 3, the method for creating a program schedule is described. The first step in preparing a client's program schedule in the management system 2 is to import the ticket allocation from the event information. This insures accuracy of the ticket allocation in the program schedule. A program manager then arranges a schedule around the ticketed event, taking into considerations transfer times, security, specific desires of the client and individual guest accommodations. Hospitality information (e.g. hotel location, number of meal, transfer request) aids in creation of the schedule. Thus, after hospitality information has been imported, the transportation, then meals then leisure time may be scheduled sequentially as shown in steps 140, 150 and 160.

Returning to the main screen, the user may select an accommodations option. Doing so presents a user interface that provides information on rooms, room numbers, room type, and other room information. From this, the operator can assign guests to each particular room. A rooming list report may include a summary of the rooming lists, including pre- and post-extensions.

Each client group's room allocation is made available to the client and information regarding the accommodation manager assigned to the client is also made available. The accommodations manager allocates rooms to each guest of the client group. Room assignments may be based on guest preferences (e.g. non-smoking, handicapped, view, balcony, etc.). According to room block assigned to the client, the accommodations manager makes decisions on how best to assign the given rooms with respect to guest preferences.

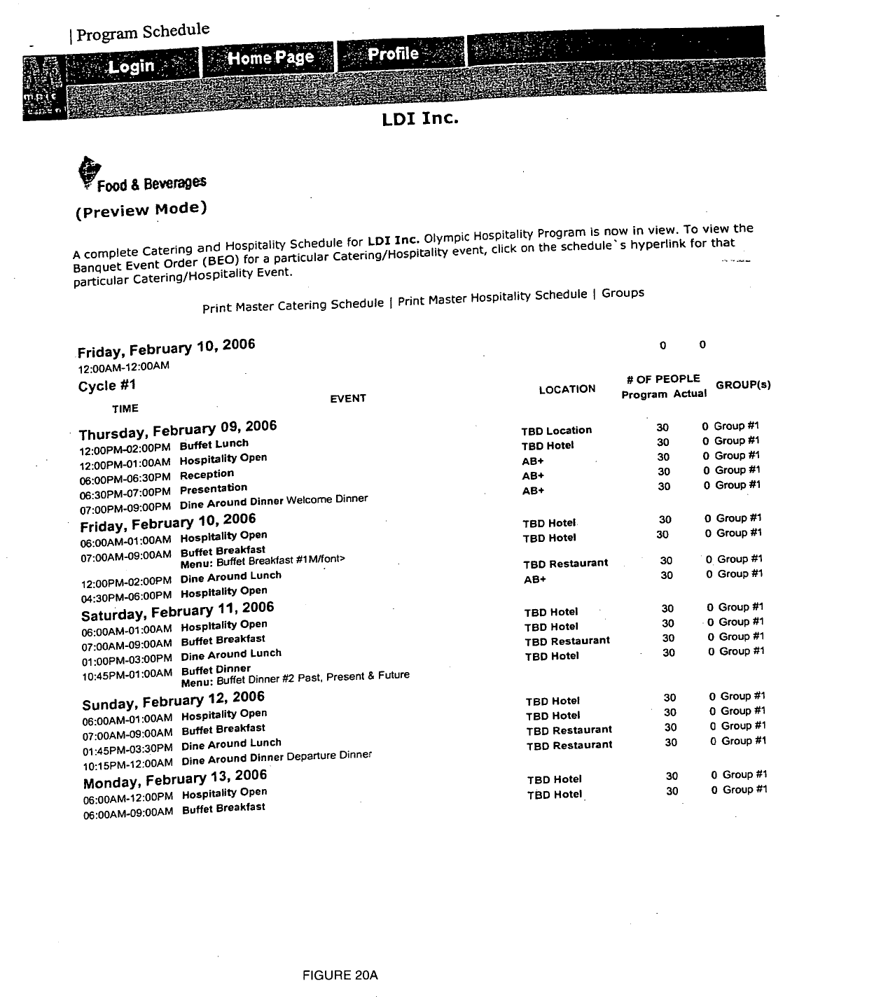

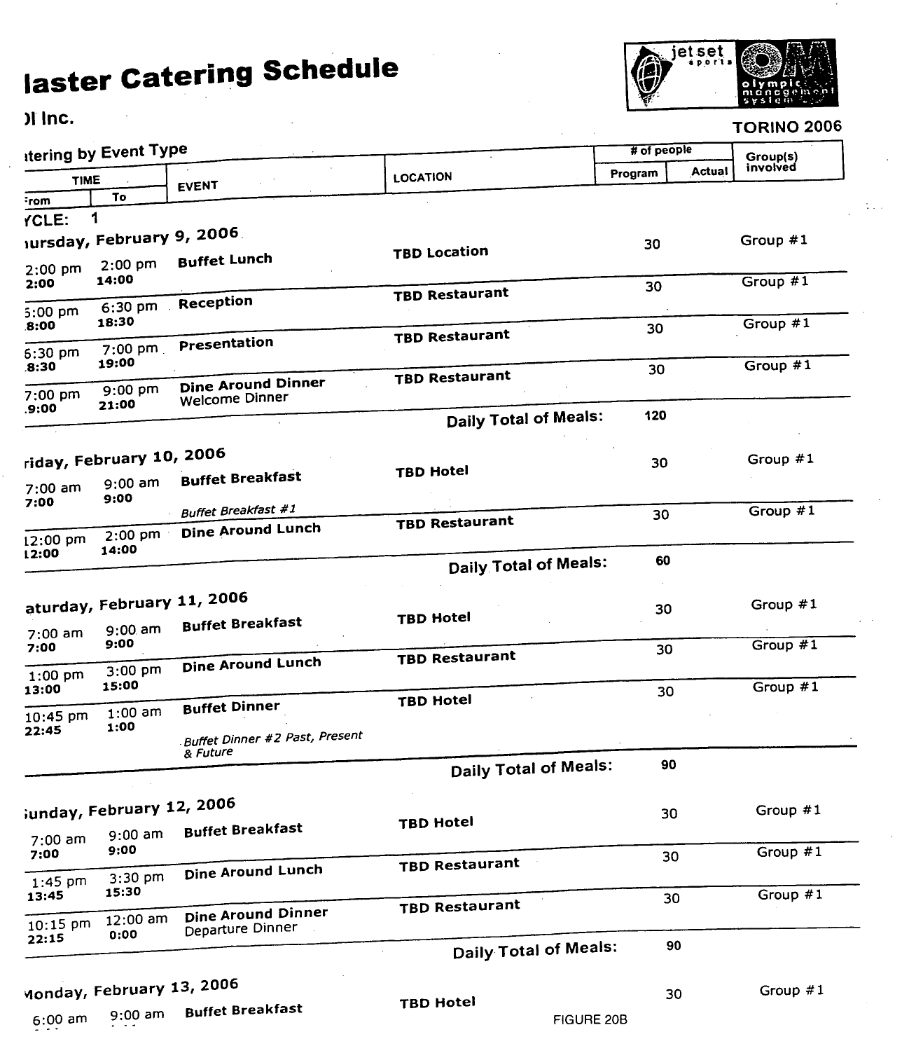

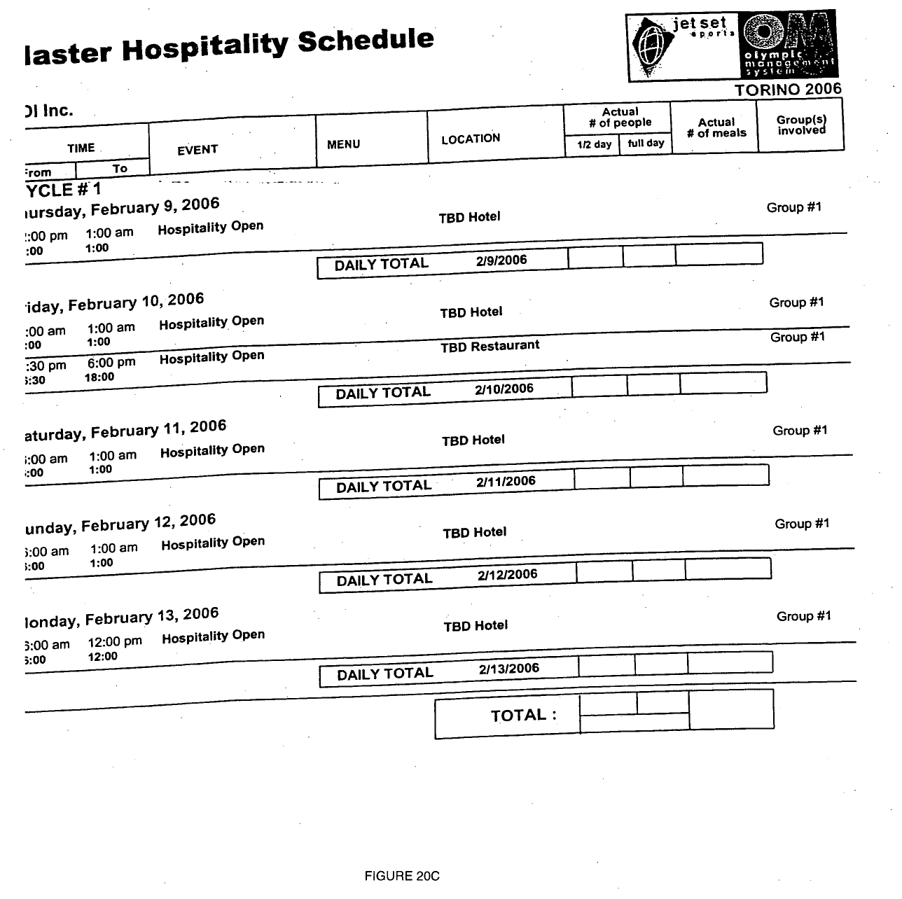

Returning again to the main screen, the user may select the food and beverage option. This will cause a display of the user interface depicted, for example, in FIG. 20a. This screen shows a view of the catering hospitality schedule for the group. From this screen, the user can print a master catering schedule shown, for example, in FIG. 20b, print a master hospitality schedule shown, for example, in FIG. 20c or show a view of the food and beverage schedule by group as shown, for example, in FIG. 20a.

The food and beverage portion of the client hospitality program extracts meals from the program schedule and allows for selecting the menu, table configuration, linens, floral, wines, and other details for the meal within a record. Once completed the management system 2 sends, from the record, instruction for each meal to the hotel and/or restaurant, as well as management staff, insuring that those concerned may be aware of details of each meal event. A full report based on the final cost of the meals, sale price per meal is available to the client.

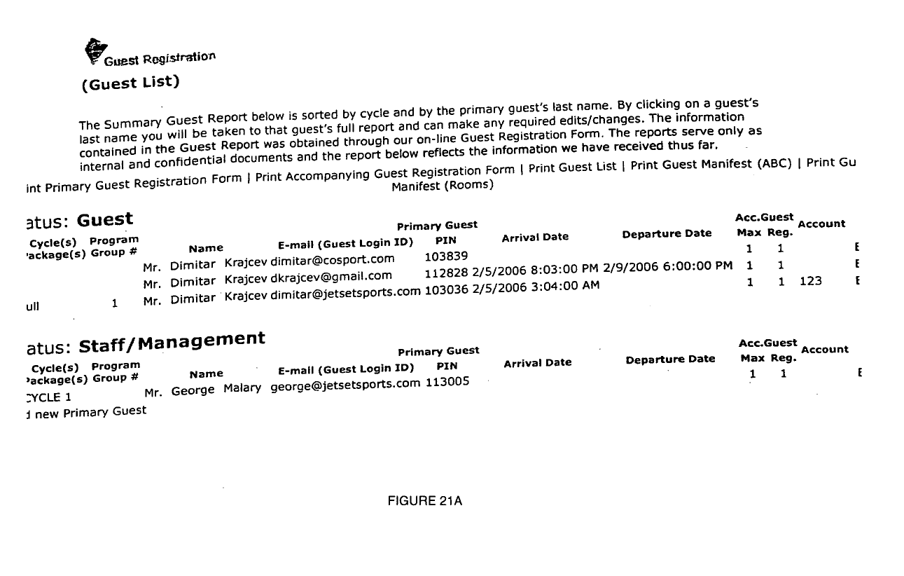

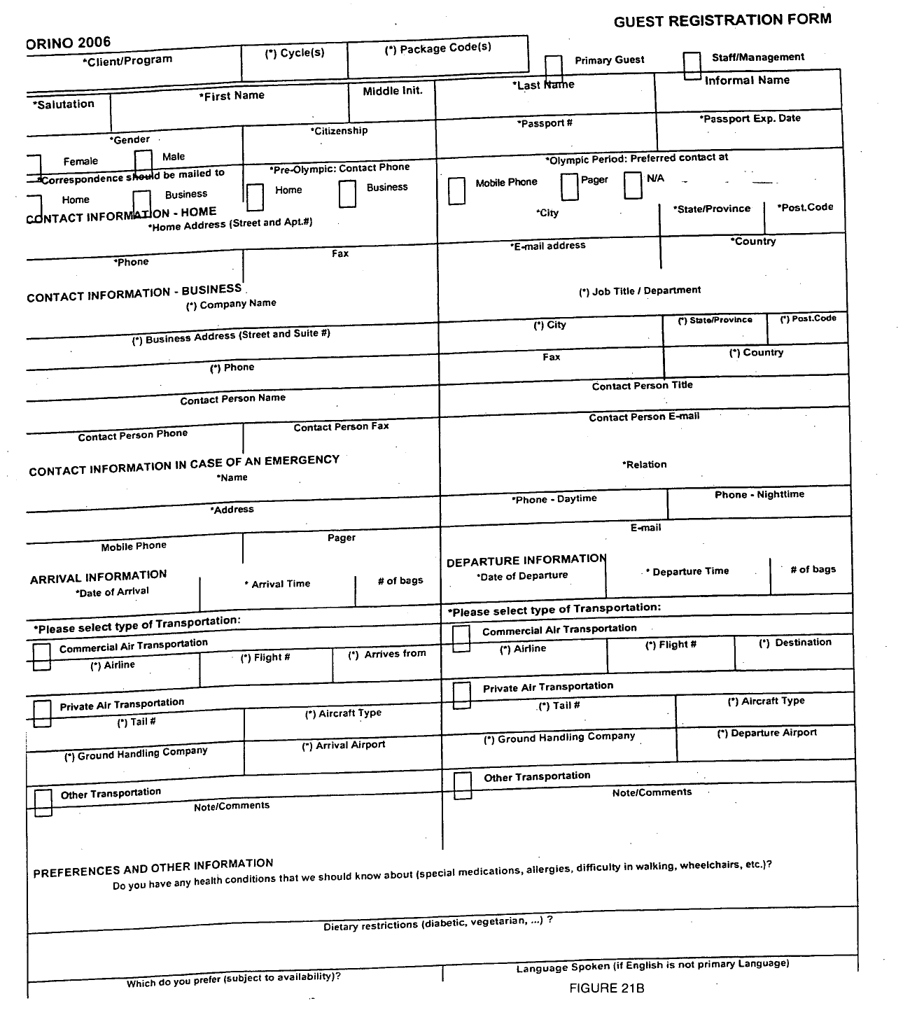

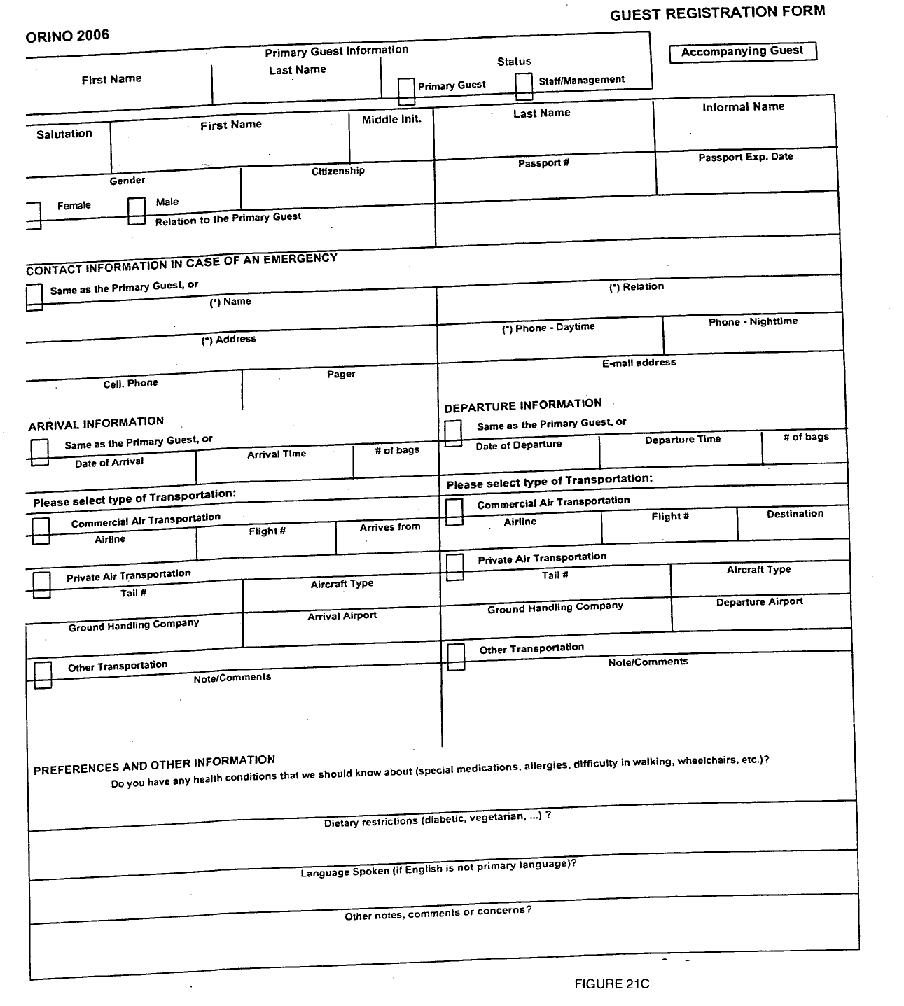

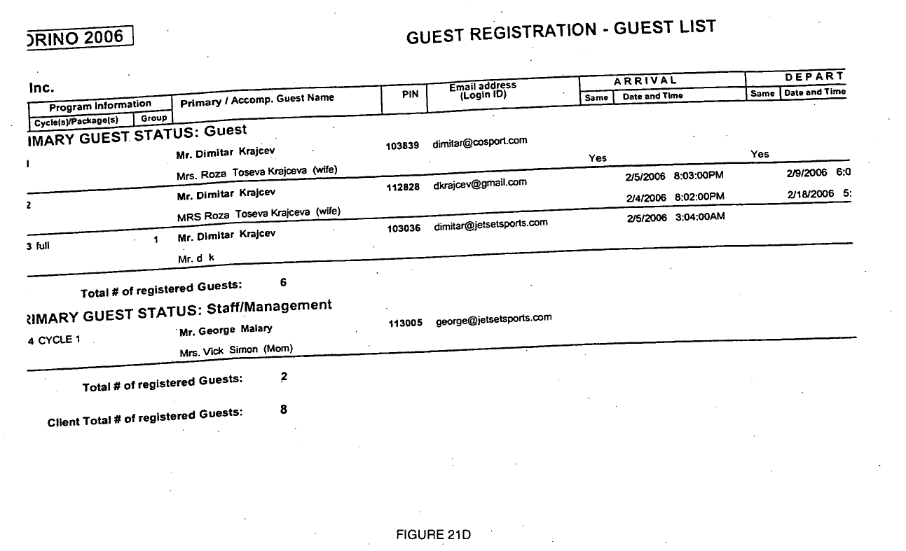

When the guest registration option is selected from the main screen, the user interface may display the information shown in FIG. 21a. This screen also enables an operator to add a new primary guest. If this option is selected, an add new guest dialogue box is presented for the operator to complete. Additional options from this user interface enable a program manager or group coordinator to select a primary guest registration form which is shown, for example, in FIG. 21b. Additionally, the user may select to print an accompanying guest registration form which is shown, for example, in FIG. 21c. Another option is for the user to print a guest list which displays the information shown, for example, in FIG. 21d. Additionally, the user may print a guest manifest.

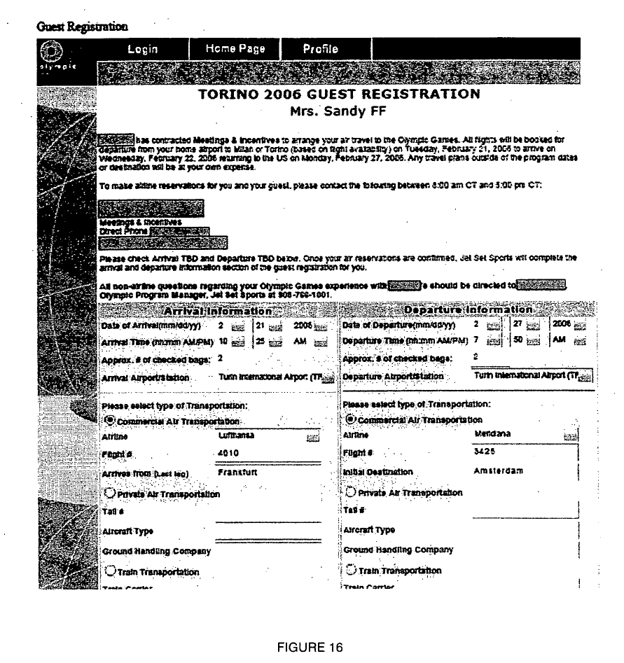

The guest registration information is created in the management system 2 by a program manager for each program guest. The information includes individual records, logins, and passwords, for access to the on-line guest registrations system. An email may be sent to each guest inviting them to visit the on-line guest registration system, via a web link along with their personal login and password. The invitation is pre-formatted and generated by the management system. FIG. 16 is an example embodiment of a guest registration system. Guest my complete personal information including address, passport number, and nationality; arrival and departure information; guest preferences (e.g., food allergies, smoking rooms, etc); and accompanying guest information. This information can be submitted or amended by the client's program manager. Each subsequent time a guest access their on-line guest registration and makes any changes or addition to the information, the management system 2 automatically generates a notification (e.g., e-mail, instant message, etc.) to the program manager informing them of the additions/alterations that have been made by the guest. Once a guest has been entered in the guest registration system, their accommodations assignments can be made by the accommodations manager.

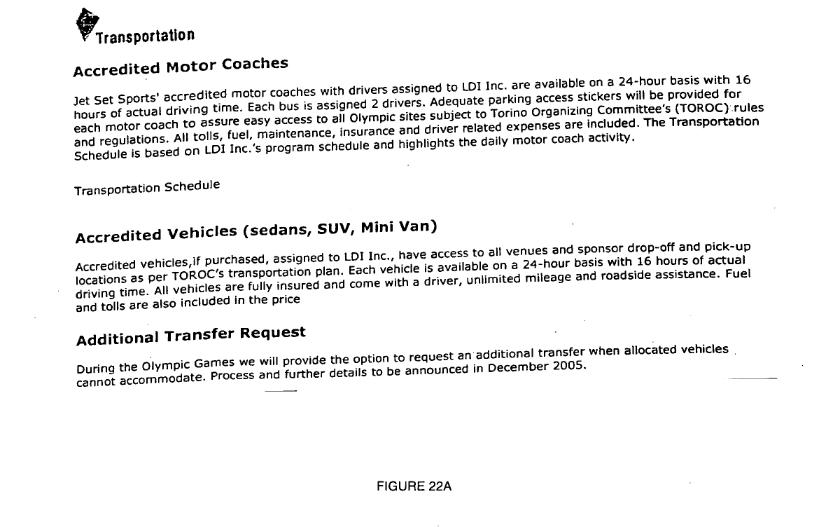

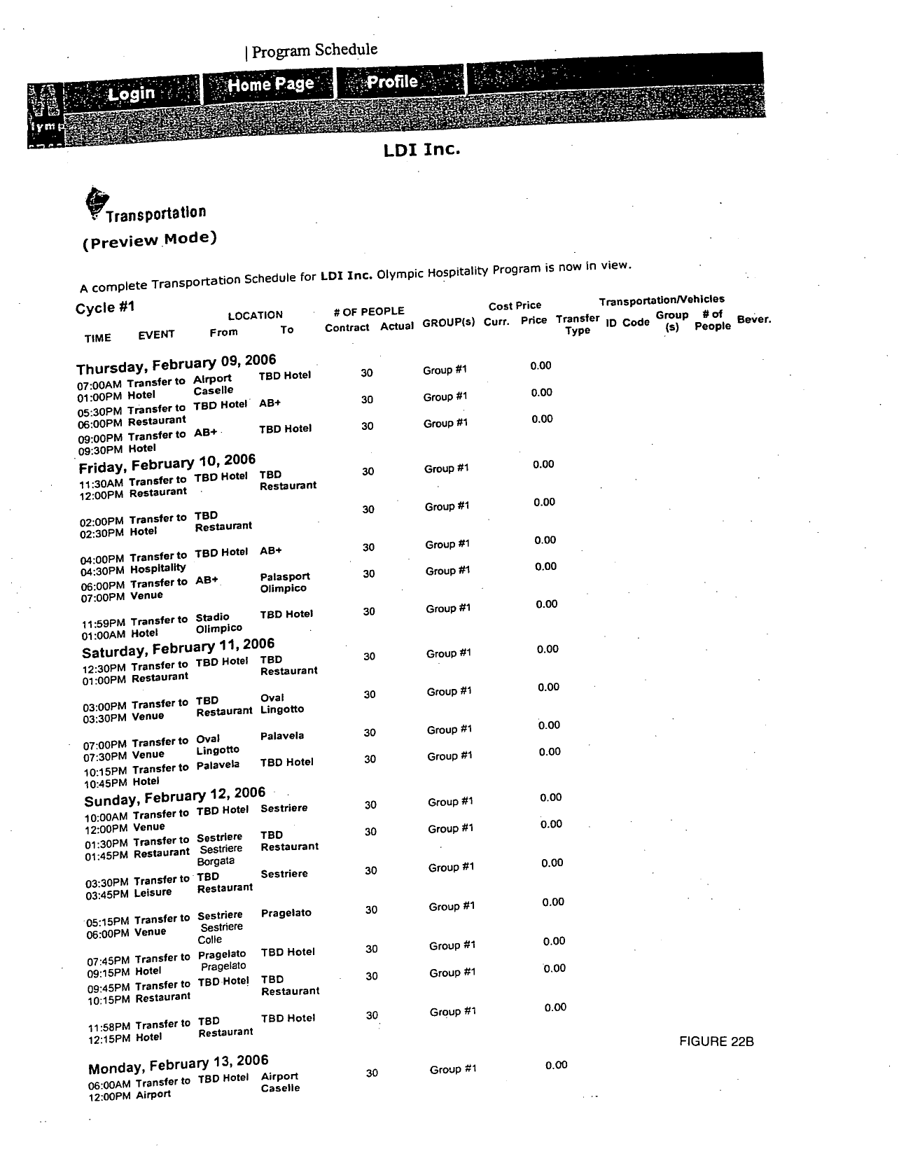

Returning again to the main screen, a transportation option enables the user to view and manage transportation information. As shown, for example, in FIG. 22a, the transportation screen enables a user to select a transportation schedule option which will display the transportation schedule as shown, for example, in FIG. 22b. Additionally, other transportation-related information can be viewed and/or managed through this portion of the interface.

The transportation section of the client program extracts transfer information from the program schedule to compile a complete transportation schedule for the vehicles assigned to the client program. The transportation schedule is also utilized for individual program management to communicate daily schedules to drivers and also by the transportation director to track movement of vehicles. Optionally, GPS devices on vehicles may also be tracked.

Returning to the main screen, the airport manifest option enables the user to select and cause to be displayed an airport manifest interface from which an airport manifest report can be printed. Additionally, the user may select a letter of operation option from the main screen which serves as a final communication to the hotel confirming the details of the program.

Airport manifest details flight information supplied by each guest in the guest registration system. Based on this information the management system 2 will generate a report for the arrival and departure complete with airport (or train station, bus station, or any other type of transportation hub), flight details, arrival and departure times, quantity of luggage etc. to assist the program manager and director with scheduling of staff and transfers.

The gift program allows each guest of the client group to be presented with gifts selected from a complete list of suggested items available on the management system, recommending suppliers and suggested gift schedules. Various collaterals (e.g., save the date cards, thank you notes) may be also included in the management system 2 along with recommended suppliers and sample text for each.

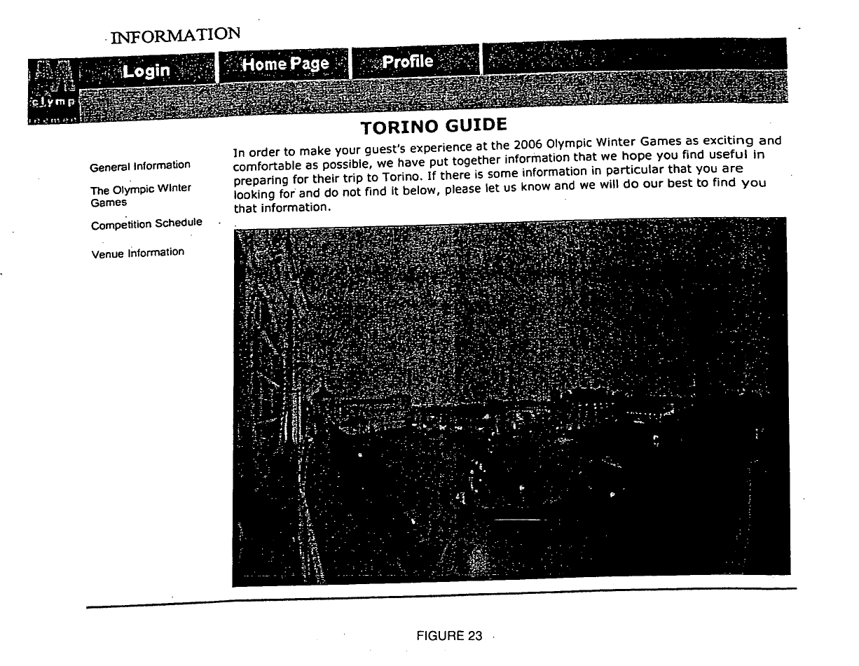

Returning again to the main screen, a local information icon may be presented to enable the user to view selected information regarding the location of the event. As shown, for example, in FIG. 23, a guide to Torino is displayed to enable additional information about that host city to be viewed. The city/event guide feature includes a comprehensive guide to the event, event host city, history of the event and/or interesting facts. The city guide may include maps and a description of local customs.

In conjunction with each client, a program manager establishes a letter of operations to serve as the master instruction guide to hotel, restaurants, and program staff. The letter details facets of the program, a brief outline of the client group, notable VIP's, special requests, billing instructions, along with the program schedule, meal schedule, and program management contact details. The letter of operations is posted on the client's homepage on the management system, which can be updated or amended as necessary, until a final version is ready to those parties concerned.

Returning again to the main screen, a staff option enables a user to select this option to see a list of the resumes and pictures of staff and to handle staff assignments for individual groups to the extent applicable. The staff section of the client program indicates the host who may be chosen to escort the guests throughout the hospitality program. Once selected and allocated to a specific client group, the host's resume, photo, and other relevant details may be posted on the client group's staff page, for the client to review and approve.

While the invention has been described primarily in connection with Olympic events, the invention is not so limited. Aspects of the invention may also be used in connection with hospitality programs (or other packages relating to other international or national sporting events (e.g., World Cup, World Series, Grand Prix, Superbowl, and other events). While aspects of the invention may primarily be directed to hospitality programs, various aspects of the invention may be used with other types of travel-related packages such as foreign travel, sightseeing tours, and/or corporate sponsored events.

In yet another alternative embodiment, the event management system 2 may be linked with airline inventory in order to provide travel arrangements in addition to hospitality arrangements.

We claim:

1. A computer implemented system for coordinating event management and execution, comprising:
a management system for storing data related to event inventory;
an external participant for specifying one or more groups;
an internal participant of the management system for assigning pieces of the event inventory to one or more groups for event execution, wherein event execution is carried out according to a program schedule;
a guest registration module for registering one or more guests belonging to the one or more groups, wherein the one or more guests are registered with mobile device information; and
the mobile device receiving the program schedule during event execution.

2. The system of claim 1, wherein the management system coordinates planning for pre-event, on-site event, and post event periods.

3. The system of claim 1, wherein the management system includes modules for: administration, setup, account, timeline, schedule, food & beverage, rooms, tickets, transportation, guests, staff, and employment.

4. The system of claim 1, wherein the event inventory includes tickets, accommodation information, food and beverages, transportation, staff, gifts, hospitality venues, and local service providers.

5. The system of claim 2, wherein the pre-event planning includes means for initial event set-up, third party coordination, and client program setup and management.

6. The system of claim 5 wherein initial event set-up includes collecting event related inventor.

7. The system of claim 5, wherein one or more third party coordinators provide products and services local to event location including hotel rooms, transportation, staffing agencies, individual staff, entertainment, food & beverage, venues, or gift vendors.

8. The system of claim 5, wherein the means for client program setup and management further includes a hospitality program including components for program timeline, events, program schedule, accommodations, food and beverages, guest registration, transportation, airport manifests, gift program, city/event guide, letters of operation, and/or staff.

9. The system of claim 8, wherein the management system coordinates multiple hospitality programs.

10. The system of claim 1, wherein the guest registration module further includes means for creating a guest profile.

11. The system of claim 10, wherein the guest profile includes initial registration information and event specific information.

12. The system of claim 11 wherein the initial registration information includes mobile device identifier, pager, email, residence, fax, languages spoken, emergency contact, or identifying number.

13. The system of claim 10 wherein the initial registration information is retained for future events.

14. The system of claim 11, wherein the event specific information includes arrival/departure times, accommodation preferences, dining preferences, mobile device request, event preferences, or hospitality request.

15. The system of claim 1, wherein the management system stores staff profile information including at least staff mobile device information.

16. The system of claim 1, wherein mobile device includes means for receiving real-time updated related to event information, transportation, accommodations, scores, venues, seating, tickets, or food and beverages.
